(19) United States
(12) Patent Application Publication
(10) Pub. No.: US 2026/0241740 A1
(43) Pub. Date: Aug. 20, 2026

(54) SECURITY DEVICES AND METHODS OF MANUFACTURE THEREOF

(71) Applicant: DE LA RUE INTERNATIONAL LIMITED, Basingstoke, Hampshire (GB)

(72) Inventors: John GODFREY, Basingstoke (GB); Rebecca LOCKE, Basingstoke (GB)

(73) Assignee: DE LA RUE INTERNATIONAL LIMITED, Basingstoke, Hampshire (GB)

(21) Appl. No.: 19/161,129

(22) PCT Filed: Feb. 27, 2024
(86) PCT No.: PCT/GB2024/050526

§ 371 Date: Aug. 29, 2025

(30) Foreign Application Priority Data
Mar. 2, 2023 (GB) 2303105.7

(51) Int. Cl. B42D 25/324; B41M 3/14; B42D 25/29; B42D 25/351; B42D 25/387

(52) U.S. Cl. CPC B42D 25/324; B41M 3/144; B42D 25/29; B42D 25/351; B42D 25/387

(57) ABSTRACT

Optically variable security device including: a substrate; an array of focusing elements disposed in or on the substrate; and an image array disposed in or on the substrate and overlapping with the array of focusing elements, wherein the image array includes at least first and second sets of image elements, the first set of image elements and the second set of image elements being interleaved with each other, wherein the image array includes a first ink and a second ink different from the first ink, one or both of the first and second inks including a luminescent material.

### FIELD OF THE INVENTION

This invention relates to security devices that may be used, for example, on documents of value such as banknotes, cheques, passports, identity cards, certificates of authenticity, fiscal stamps, and other secure documents, in order to confirm their authenticity. Methods of manufacturing such security devices are also disclosed.

### BACKGROUND

Articles of value, and particularly documents of value such as banknotes, cheques, passports, identification documents, certificates and licences, are frequently the target of counterfeiters and persons wishing to make fraudulent copies thereof and/or changes to any data contained therein. Typically such objects are provided with a number of visible security devices for checking the authenticity of the object. By “security device” we mean a feature which it is not possible to reproduce accurately by taking a visible light copy, e.g. through the use of standardly available photocopying or scanning equipment.

One class of security devices are lenticular devices, which make use of focussing elements (such as lenses) to produce an optically variable effect, meaning that the appearance of the device is different at different angles of view and/or illumination. Such devices are particularly effective as security devices since direct copies (e.g. photocopies) will not produce the optically variable effect and hence can be readily distinguished from genuine devices.

In lenticular devices, an array of viewing elements, typically cylindrical lenses, overlies an image layer having a corresponding array of image segments, each of which depicts only a portion of an image which is to be displayed. Image segments from two or more different images are interleaved and, when viewed through the array of viewing elements, at each viewing angle, only selected image segments will be directed towards the viewer. In this way, different composite images can be viewed at different angles. Some examples of lenticular devices are described in U.S. Pat. No. 4,892,336, WO-A-2011/051669, WO-A-2011051670 and U.S. Pat. No. 6,856,462. More recently, two-dimensional lenticular devices have also been developed and examples of these are disclosed in WO2015/011493 and WO2015/011494. Lenticular devices have the advantage that different images can be displayed at different viewing angles, giving rise to the possibility of animation and other striking visual effects that allow for simple authentication of a device that is simultaneously difficult to counterfeit.

New security features are constantly sought, in order to stay ahead of would-be counterfeiters.

### SUMMARY OF INVENTION

In accordance with a first aspect of the invention, there is provided an optically variable security device, comprising:
a substrate;
an array of focussing elements disposed in or on the substrate; and
an image array disposed in or on the substrate and overlapping with the array of focussing elements, wherein the image array comprises at least first and second sets of image elements, the first set of image elements and the second set of image elements being interleaved with each other, and wherein the array of focussing elements and the image array cooperate with each other such that at a first range of viewing angles, light from the first set of image elements is directed to a viewer, and at a second range of viewing angles, light from the second set of image elements is directed to the viewer such that the device exhibits respective images at the first and second ranges of viewing angles; wherein
the image array comprises a first ink and a second ink different from the first ink, one or both of the first and second inks comprising a luminescent material which luminesces in response to irradiation at at least one excitation wavelength, wherein the first and second inks each exhibit a respective non-luminescent visible colour when illuminated with a first illumination condition that comprises illumination with visible light in the absence of the at least one excitation wavelength, and one or both of the first and second inks exhibit a visible colour when illuminated with a second illumination condition that comprises illumination with the at least one excitation wavelength; and further wherein
at least one of the first ink and the second ink exhibits a different visual appearance when illuminated with the first illumination condition compared to when illuminated with the second illumination condition, and when illuminated with at least one of the first and second illumination conditions, the first and second inks have different visual appearances from each other; such that
the security device exhibits a first optical effect when illuminated with the first illumination condition and tilted from the first range of viewing angles to the second range of viewing angles, and exhibits a second optical effect when illuminated with the second illumination condition and tilted from the first range of viewing angles to the second range of viewing angles, the second optical effect being different from the first optical effect, and wherein at least one of the first and second optical effects is an optically variable effect.

In this way, the present invention provides a (e.g. lenticular) security device that exhibits different optical effects when illuminated with different illumination conditions. This advantageously provides an increased level of authentication as compared to conventional devices that are designed to be viewed under one illumination condition only (e.g. devices designed to be viewed only in visible light). This increases the difficulty of counterfeit of such devices, since a would-be counterfeiter needs to attempt to match the different optical effects provided by the device under multiple illumination conditions.

The capability of the device to exhibit different optical effects under different illumination conditions is realised through at least one the first and second inks comprising a luminescent material (which term includes materials or substances having fluorescent or phosphorescent properties). Such materials respond visibly to irradiation at a certain wavelength or range or wavelengths outside the visible spectrum (typically within the ultra-violet, UV, region of the electromagnetic spectrum), typically by emitting light of a particular colour characteristic of the material in question.

Additionally, both the first ink and the second ink each exhibit a respective non-luminescent visible colour when illuminated with visible light in the absence of the at least one excitation wavelength. Thus, the security device exhibits a visible (e.g. coloured) optical effect when illuminated with the first illumination condition, meaning that the device exhibits different (e.g. coloured) optical effects when illuminated with the different illumination conditions.

Throughout this specification, the term “visible colour” means a colour (e.g. chromatics such as red, blue, yellow, green, brown etc.) which can be seen by the naked human eye under the stated illumination conditions. The term “non-luminescent visible colour” simply refers to the colour exhibited by the first and second inks when illuminated with visible light in the absence of the at least one excitation wavelength.

“Visible light” refers to light having a wavelength within the visible spectrum, which is approximately 400 to 750 nm. It is most preferable that the visible light is white light, i.e. contains substantially all the visible wavelengths in more or less even proportion. The first illumination condition “comprising illumination with visible light in the absence of the at least one excitation wavelength” may also be referred to herein for brevity as “visible light”, “visible light only” or “non-UV light”. The ultra-violet spectrum typically comprises wavelengths from about 200 nm to about 400 nm.

The arrangement of the first and second inks is such that the first optical effect (exhibited by the device when illuminated with the first illumination condition) is different from the second optical effect (exhibited by the device under the second illumination condition). This is at least in part due to the feature that at least one of the first ink and the second ink exhibits a different visual appearance when illuminated with the first illumination condition compared to when illuminated with the second illumination condition, and when illuminated with at least one of the first and second illumination conditions, the first and second inks have different visual appearances from each other. In this way, the first and second optical effects may be considered to differ in the relative appearances of the respective images exhibited by the device at the first and second ranges of viewing angles. The relative appearances under the different illumination conditions may differ in at least one of the graphical form or the colour of the images exhibited at the first and second ranges of viewing angles. In this way, the first and second optical effects may be considered to differ in information content.

The term “different visual appearance” may include a difference in exhibited visible colour (e.g. an ink exhibits “red” under the first illumination condition and “blue” under the second illumination condition), or a change in appearance due to the ink not exhibiting a response to the at least one excitation wavelength (e.g. an ink exhibits “red” under the first illumination condition, but does not have a UV response and therefore does not exhibit (e.g. “emit”) a visible colour under the second illumination condition).

Thus, the security device of the present invention advantageously exhibits different optical effects when illuminated with the first and second illumination conditions. In preferred embodiments, when the security device is illuminated with one of the first and second illumination conditions, the first and second inks exhibit substantially the same visible colours. This could be substantially the same non-luminescent visible colour under the first illumination condition, or substantially the same colour under the second illumination condition. This advantageously provides a further requirement for a would-be counterfeiter to attempt to replicate, thereby further enhancing the security level of the device. For example, in such embodiments it is important to control the mixture of pigments and/or dyes in the first and second inks to achieve the correct balance between the desired colour in the visible spectrum and the correct colour when illuminated with the second illumination condition.

“Substantially the same” visible colours are those which appear the same as one another in a cursory inspection (by the naked human eye) although they may not be an exact match under close examination. By the same logic, “different” colours are those which clearly present a contrast to one another that is visible to the naked human eye even without a close inspection.

For example, in preferred embodiments, two colours will be considered substantially the same as one another if the Euclidean distance ΔE*_{ab} between them in CIELAB colour space (i.e. the CIE 1976 L*a*b* colour space) is less than 3, more preferably less than 2.3. The value of ΔE_{ab} is measured using the formula

$$Δ {E}_{ab}^{*} = \sqrt{{{{( Δ L \text{*)}}^{2} + ( Δ a \text{*)}}^{2} + ( Δ b \text{*)}}^{2}}$$

Where ΔL*, Δa* and Δb* are the distance between the two colours along the L*, a* and b* axes respectively (see “Digital Color Imaging Handbook” (1.7.2 ed.) by G. Sharma (2003), CRC Press, ISBN 0-8493-0900-X, pages 30 to 32). Conversely, if ΔE*_{ab} is greater than or equal to 3 (or, in more preferred embodiments, greater than or equal to 2.3), the two colours will be considered different. The colour difference ΔE*_{ab} can be measured using any commercial spectrophotometer, such as those available from Hunterlab of Reston, Virginia, USA.

In some embodiments, both the first and second inks comprise a luminescent material which luminesces in response to irradiation at the at least one excitation wavelength so as to exhibit a visible colour when illuminated with the second illumination condition. In such devices in which both the first and second inks comprise a luminescent material, this can provide particularly complex visual effects that enhance the security level of the device. Typically, unless the luminescent materials have the desired body colour, the first and second inks may additionally comprise other substances, such as non-luminescent pigments and/or dyes, in order to create the desired colour in visible light.

In some preferred embodiments, when illuminated with the first illumination condition, the first and second inks exhibit substantially the same non-luminescent visible colours. In such embodiments, and wherein both the first and second inks comprise a luminescent material, when illuminated with the second illumination condition, the second ink typically exhibits a visible colour that is different from the visible colour exhibited by the first ink. In some alternative embodiments, when illuminated with the first illumination condition, the first and second inks may exhibit different non-luminescent visible colours, and when illuminated with the second illumination condition, the first and second inks exhibit substantially matching visible colours.

As discussed above, at least one of the first ink and the second ink exhibits a different visual appearance when illuminated with the first illumination condition compared to when illuminated with the second illumination condition. Typically, at least one of the first ink and the second ink exhibits a different visible colour when illuminated with the first illumination condition compared to when illuminated with the second illumination condition.

As discussed, the optically variable security device of the present invention comprises an image array having at least first and second sets of image elements. The array of focussing elements and the image array cooperate with each other such that at a first range of viewing angles, light from the first set of image elements is directed to a viewer, and at a second range of viewing angles, light from the second set of image elements is directed to the viewer such that the device exhibits respective images at the first and second ranges of viewing angles. In this way, each set of image elements may be referred to as an “image channel”. In some embodiments, the first set of image elements comprises the first ink, but not the second ink; and the second set of image elements comprises the second ink, but not the first ink. In other words, in such embodiments, the first “channel” comprises the first ink but not the second ink, and the second “channel” comprises the second ink but not the first ink.

In such embodiments, the graphical form of the images may remain the same under the first and second illumination conditions, but the relative colours of the exhibited images may change upon a change from the first to the second illumination conditions. For example, when illuminated with the first illumination condition, the device may exhibit alphanumerical character “A” at the first range of viewing angles, and the alphanumerical character “B” at the second range of viewing angles, with both the “A” and the “B” being blue. Upon a change in illumination conditions to the second illumination condition, the same graphical forms may be exhibited (i.e. the alphanumerical character “A” at the first range of viewing angles and the alphanumerical character “B” at the second range of viewing angles), but with different colours; for example a blue “A” and a red “B”. In such embodiments, both the first and second optical effects are optically variable effects, exhibiting an “image switch” effect upon a change from the first range of viewing angles to the second range of viewing angles.

In some embodiments in which the first channel comprises the first ink and not the second ink, and the second channel comprises the second ink and not the first ink, when illuminated with one of the first or second illumination conditions, the security device exhibits substantially the same image at both the first set of viewing angles and the second set of viewing angles, and when illuminated with the other of the first or second illumination conditions, the security device exhibits different images at the first set of viewing angles and the second set of viewing angles. Thus, in such embodiments, only one of the first and second optical effects is optically variable. Herein, two images are considered to be the same if they are the same in both graphical form and colour.

As discussed, in some devices according to the invention, the first set of image elements comprises the first ink but not the second ink, and the second set of image elements comprises the second ink but not the first ink. It is also envisaged that the same “channel” may comprise both the first and second inks. Thus, in some embodiments, the first set of image elements comprises both the first ink and the second ink. Such embodiments advantageously allow complex visual effects to be exhibited with a change in illumination conditions. For example, the different response characteristics of the first and second inks may be utilized to change the graphical form of the image exhibited at the corresponding range of viewing angles upon a change from the first illumination condition to the second illumination condition. Thus, in some embodiments, when illuminated with the first illumination condition, the security device exhibits a first image at the first range of viewing angles; and when illuminated with the second illumination condition, the security device exhibits a second image at the first range of viewing angles, wherein the graphical form of the first image is different from the graphical form of the second image.

In some embodiments, the second set of image elements may define gap regions that do not comprise ink or other image material. In other words, in such devices, the image elements of the first set of image elements are spaced apart by regions absent of ink or other image material. Thus, at the range of viewing angles corresponding to the second set of image elements, the viewer perceives a uniform colourless, or “blank” appearance.

In some embodiments, the second set of image elements may comprise at least one of the first ink and the second ink. Thus, in such embodiments, the security device exhibits a colour image at the second range of viewing angles, at least under one of the illumination conditions. This advantageously provides further complexity to the overall optical effect exhibited by the device, thereby increasing the level of security.

Thus far, we have discussed the various secure effects that may be exhibited through the use of an image array comprising first and second inks. The image array may comprise only the first and second inks. However, it is envisaged that the image array may comprise a further ink or other image material in order to provide further secure effects. Thus, in some embodiments, the second set of image elements may comprise a third ink that is different from the first ink or the second ink. The third ink typically exhibits a non-luminescent visible colour. The third ink may or may not comprise luminescent material.

In some embodiments, the security device may further comprise a (e.g. continuous) cover layer on or extending over the image array, wherein the cover layer exhibits a visible colour when illuminated with at least one of the first or second illumination conditions. In this way, such a cover layer may add further visual effects to the images exhibited by the device, thereby further enhancing its security level. The cover layer may exhibit a non-luminescent visible colour when illuminated with the first illumination conditions (e.g. contains a non-luminescing coloured dye or pigment) and/or contains a luminescent material that exhibits a visible colour under the second illumination condition. The cover layer may exhibit a different visual appearance when illuminated with the first illumination condition compared to when illuminated with the second illumination condition. In some embodiments, the cover layer may be substantially transparent and colourless when illuminated with the first illumination condition, and exhibit a visible colour when illuminated with the second illumination condition. Such an arrangement provides a latent visual effect that is only present under the second illumination condition.

In embodiments in which a cover layer is used, the image array is typically formed as a single layer disposed in or on the substrate. In this way, the image array may be considered to be an “image layer”. The cover layer may be disposed on or over the image layer on a distal side of the image layer relative to the array of viewing elements, in which case it may be termed an “over layer”. Alternatively, the cover layer may be disposed on a proximal side of the image layer relative to the array of viewing elements, in which case it may be termed an “under layer”. Such an under layer is at least partially transparent such that the image layer is visible through the under layer.

Alternatively, in some embodiments, the second set of image elements may be formed by a (e.g. continuous) colour layer extending on or over the first set of image elements. Thus, in such devices, the image array is formed from two “sub-layers”. An image array in which the second set of image elements is formed by a colour layer extending on or over the first set of image elements advantageously reduces the registration tolerance required in order to form the interleaved first and second sets of image elements. Typically, the colour layer is provided on a distal side of the first set of image elements with respect to the array of viewing elements, in which case the first set of image elements are substantially opaque under at least one of the first and second illumination conditions.

As has been discussed above, a security device according to the present invention exhibits a first optical effect when illuminated with the first illumination condition and tilted from the first range of viewing angles to the second range of viewing angles; and exhibits a second, different, optical effect when illuminated with the second illumination conditions and tilted from the first range of viewing angles to the second range of viewing angles. Preferably, each of the first and second optical effects comprises the security device exhibiting at least one image as the device is tilted from the first range of viewing angles to the second range of viewing angles. At least one of the first and second optical effects is an optically variable effect, in which case the respective images exhibited at the first and second ranges of viewing angles are different under the respective illumination conditions. Such an effect may be termed an “image switch” effect.

Preferably, the at least one image exhibited by the device is in the form of indicia or an indicium, preferably one or more geometric shapes, letters, logos, currency signs or other symbols. In some implementations, the at least one image exhibited by the device may be a complex multi-colour image such as a portrait.

When illuminated with one of the illumination conditions, the same image may be exhibited at the first range of viewing angles and the second range of viewing angles (in other words, the perceived image exhibited by the device remains the same as the device is tilted). Preferably however, each of the first and second optical effects is an optically variable effect.

In some embodiments, the image array may comprise only the first and second sets of image segments. In other words, the device may have exactly two (e.g. interleaved) image channels, and may be referred to as a “two-channel device”. However, in some embodiments, the image array may further comprise a third set of image elements, and wherein at a third range of viewing angles, light from the third set of image elements is directed to the viewer. In general, the invention applies to all n-channel lenticular devices, where n is equal to or greater than 2.

For two-channel devices, the optically variable optical effect that is exhibited under at least one of the first and second illumination conditions is typically an “image switch” effect, in which two separate (e.g. “discrete”) images are exhibited by the device in dependence on viewing angle. In embodiments in which the image array further comprises a third (or more) sets of image elements, when illuminated with at least one of the first and second illumination conditions, the security device may exhibit an animation sequence as it is tilted between the first, second and third ranges of viewing angles. This may further increase the level of difficulty of counterfeiting the device.

As has been discussed above, the second illumination condition comprises illumination with the at least one excitation wavelength. Typically, the second illumination condition comprises illumination with a combination of visible light and the at least one excitation wavelength. In such cases, the body colour of the ink that is visible in visible light will need to be taken into account in order that the ink appears in the desired colour under a combination of visible light and the at least one excitation wavelength. Alternatively, the second illumination condition may comprise illumination with (e.g. substantially) only the at least one excitation wavelength. In other words, in such embodiments the second illumination condition comprises an absence of, or a negligible amount of, visible light and/or wavelength(s) different from the at least one excitation wavelength.

Typically, the at least one excitation wavelength is at least one UV wavelength in the range of 200 nm to 400 nm preferably 235 nm to 380 nm. In other words, the one or more (typically both) of the first and second inks will luminesce in response to at least one UV wavelength. In particularly preferred implementations, the at least one ink will be responsive to a wide range of UV wavelengths. Thus, preferably, the excitation wavelength is substantially any wavelength in the range of 200 nm to 400 nm, preferably 235 nm to 380 nm. In this case it should be understood that it is not necessary for all such wavelengths to be included in the illuminating irradiation to elicit a response from the luminescent material(s)-just any one wavelength within that range.

In cases where both the first and second inks comprise a luminescent material, the respective luminescent materials may have different response spectra (i.e. may each be responsive to a different range of UV wavelengths), but it is necessary that both luminescent materials have at least one UV wavelength in common to which they are both responsive.

As has been discussed herein, one or both of the first and second inks comprises a luminescent material. Typically, the luminescent material is a fluorescent material. In some embodiments, at least one of the first and second inks comprises a luminescent material that is phosphorescent. This can provide further complex effects as the luminescent emission due to phosphorescence when the device is illuminated with the second illumination condition may continue (e.g. for a short time period, typically on the order of seconds) after the at least one excitation wavelength has been removed. This may be particularly advantageous if the first set of image elements comprises a phosphorescent material and the second set of image elements does not comprise a phosphorescent material, as the phosphorescent response will be visible at the range of viewing angles corresponding to the first set of image elements, but not at the range of viewing elements corresponding to the second set of image elements.

In some embodiments, the security device may further comprise a static print working configured such that, when the device is illuminated with the second illumination condition, the static print working forms a combined image with at least one of the first and second sets of image elements at the respective range of viewing angles. By “static” print working, we mean that the print working does not exhibit an optically variable effect upon tilting the device (e.g. under each illumination condition, the static print appears the same at both the first and second range of viewing angles). The static print working is typically provided outside of the lateral footprint of the array of focussing elements. The static print working preferably comprises an ink that comprises a luminescent material, with the ink preferably appearing colourless when illuminated with the first illumination condition.

WO2004/050376 and WO2018/206936 disclose examples of ink compositions suitable for use as luminescent inks used in the present invention, and further examples of appropriate inks will be given below.

In the present invention, the array of focussing elements may take various forms. In preferred embodiments, the array of focussing elements comprises an array of lenses. The focussing elements may be adapted to focus light in one dimension, in which case the focussing elements are preferably (e.g. elongate) cylindrical focussing elements, or adapted to focus light in at least two (e.g. non-parallel, preferably orthogonal) directions, in which case the focussing elements are preferably spherical or aspherical focussing elements.

The pitch of the focussing elements is typically in the range of 10 μm to 200 μm, preferably 20 μm to 200 μm, more preferably 50 μm to 200 μm.

The focussing elements can be produced by known means such as embossing or cast-curing, and may be formed directly on the substrate or on a separate substrate from which they are transferred to the device, or which is attached to and then forms part of the device substrate. In this disclosure, it should be noted that where a component is described as being “on” another component, there may or may not be direct contact between those components. For instance, the focussing elements may be disposed directly on the surface of the substrate, or there may be an intervening layer such as a primer between them and the substrate. In some embodiments the focussing elements may be formed (e.g. embossed) into the substrate material itself.

Preferably, the image array is located approximately in the focal plane of the array of focussing elements. The required spacing between the focussing elements and the image array may be provided by the substrate itself and/or any optical spacing or pedestal layer as is known in the art.

In typical embodiments, the substrate is at least semi-transparent (preferably fully transparent), and the array of focussing elements is provided on a first surface of the substrate and the image array is provided on a second, opposing surface of the substrate. It will be appreciated that in such configurations the substrate will need to be at least semi-transparent (the term “transparent” herein being used to mean optically clear and non-scattering, although may carry a coloured tint). In this case, the substrate is typically formed of one or more polymer materials, such as BOPP, PET, PE, PC or the like. In alternative embodiments, the focussing elements may be disposed on the same side of the substrate as the image layer, e.g. by building an optical spacing into their design or providing an at least semi-transparent pedestal layer between the focussing elements and the image layer. In such embodiments, the substrate need not be semi-transparent and may be of any type, opaque or otherwise. This includes paper substrates, although polymer-based substrates are preferred.

The image array is preferably provided by a print working, preferably printed by a gravure, intaglio, screen, micro-intaglio, flexographic or (wet or dry) lithographic technique, or by a digital printing technique, for example inkjet or laser printing. With careful design and implementation, such techniques can be used to print image elements with a line width of between 25 μm and 100 μm. For example, with flexographic or wet lithographic printing it is possible to achieve line widths down to about 10-25 μm. In this way, the image elements may be described as “microimage elements”. The image array is typically formed as a single layer (“image layer”) disposed in or on the substrate.

A second aspect of the invention provides a security article comprising the security device as described above, wherein the security article is preferably a security thread, strip, foil, insert, transfer element, label, patch, or a data page for a security document. Security articles such as these, carrying the security device, can then be applied to or incorporated in a security document or any other object, e.g. by hot stamping, cold stamping, via adhesive or lamination, or by introduction during papermaking. Examples will be provided below.

A third aspect of the invention further provides a security document comprising a security device or security article as described above, wherein the security document is preferably a banknote, cheque, passport, identity care, driver's license, certificate of authenticity, fiscal stamp or other document for securing value or personal identity. The security device can either be formed directly on the security document, in which case the document substrate may act as the substrate of the security device, or could be formed on a security article which is then applied to or incorporated into the security document as described above.

In accordance with a fourth aspect of the present invention there is provided a method of manufacturing a security device, comprising:
(a) providing a substrate;
(b) applying an array of focussing elements to the substrate; and
(c) forming an image array in or on the substrate, the image array overlapping with the array of focussing elements; wherein the image array comprises at least first and second sets of image elements, the first set of image elements and the second set of image elements being interleaved with each other, and wherein the array of focussing elements and the image array cooperate with each other such that at a first range of viewing angles, light from the first set of image elements is directed to a viewer, and at a second range of viewing angles, light from the second set of image elements is directed to the viewer such that the device exhibits respective images at the first and second ranges of viewing angles; wherein
the image array comprises a first ink and a second ink different from the first ink, one or both of the first and second inks comprising a luminescent material which luminesces in response to irradiation at at least one excitation wavelength, wherein the first and second inks each exhibit a respective non-luminescent visible colour when illuminated with a first illumination condition that comprises illumination with visible light in the absence of the at least one excitation wavelength, and one or both of the first and second inks exhibit a visible colour when illuminated with a second illumination condition that comprises illumination with the at least one excitation wavelength; and further wherein
at least one of the first ink and the second ink exhibits a different visual appearance when illuminated with the first illumination condition compared to when illuminated with the second illumination condition, and under at least one of the first and second illumination conditions, the first and second inks have different visual appearances from each other; such that
the security device exhibits a first optical effect when illuminated with the first illumination condition and tilted from the first range of viewing angles to the second range of viewing angles, and exhibits a second optical effect when illuminated with the second illumination condition and tilted from the first range of viewing angles to the second range of viewing angles, the second optical effect being different from the first optical effect, and wherein at least one of the first and second optical effects is an optically variable effect.

The result of the method of the fourth aspect is a security device of the sort already described above in relation to the first aspect of the invention, with all the advantages discussed. Any of the preferred features described above could be provided via appropriate adaptation of the method. In particularly preferred embodiments, when the security device is illuminated with one of the first and second illumination conditions, the first and second inks exhibit substantially the same visible colours.

Advantageously, the image array is formed by a printing technique, preferably a gravure, intaglio, screen, micro-intaglio, flexographic, lithographic or digital technique such as inkjet or laser printing.

Typically, the image array is formed in a single print working. In such implementations, the image array is provided as a single image layer. The first and second inks are preferably applied to the substrate in registration with each other. Hence, desirably, the first and second inks are applied to the substrate in the same, in-line application process. For instance, each ink can be applied to the substrate sequentially in the same continuous printing process, or both of the inks (and further inks, if present) could be applied in register to a transfer blanket or roller and then applied to the substrate simultaneously.

In embodiments in which the image array is formed as a single print working, the method may further comprise providing a cover layer on or extending over the image array, wherein the cover layer exhibits a visible colour when illuminated with at least one of the first or second illumination conditions. The cover layer is typically formed by a (separate) print working, preferably by a gravure, screen, flexographic, lithographic or digital print process.

In some embodiments, the image array may be formed in a plurality of print workings, wherein the second set of image elements is formed by a colour layer extending on or over the first set of image elements. The colour layer is typically formed by a separate print working from that forming the first set of image elements. The colour layer is typically formed by a gravure, screen, flexographic, lithographic or digital print process.

The focussing elements can be produced by known means such as embossing or cast-curing, and may be formed directly on the substrate or on a separate substrate from which they are transferred to the device, or which is attached to and then forms part of the device substrate. In some cases the focussing elements may be applied to the substrate by forming (e.g. embossing) the focussing elements into the substrate material itself.

The array of focussing elements and the image array may be provided in either order. In other words, the array of focussing elements may be applied to the substrate before the application of the image array, or vice-versa. However, in preferred embodiments, the focussing elements (e.g. lenses) are applied to a first side of the substrate and the image array is applied to a second, opposing, side of the substrate simultaneously at the same location along the substrate. Such simultaneous application of the viewing elements and image layer advantageously provides highly accurate register between the two.

### BRIEF DESCRIPTION OF DRAWINGS

Embodiments of the invention will now be described with reference to the appended drawings, in which:—

FIG. 1 schematically illustrates a security document carrying a conventional lenticular security device known in the art;

FIGS. 2(a) to 2(c) schematically illustrate a conventional lenticular security device;

FIGS. 3(a) and 3(b) illustrate a security device according to an embodiment of the invention, and the visual effect thereof;

FIGS. 4 to 10 schematically illustrate the visual effects exhibited by security devices according to further embodiments of the invention;

FIG. 11 schematically illustrates a printing system suitable for forming the image array of security devices according to the invention;

FIG. 12 schematically illustrates a further printing system suitable for forming the image array of security devices according to the invention;

FIGS. 13(a) to 13(c) illustrate a security device according to an embodiment of the invention, and the visual effect thereof;

FIGS. 14 to 17 schematically illustrate the visual effects exhibited by security devices according to further embodiments of the invention;

FIGS. 18 and 19 illustrates printing systems suitable for forming the image array of security devices according to the invention;

FIGS. 20 to 23 schematically illustrate the visual effects exhibited by security devices according to further embodiments of the invention;

FIGS. 24(a) to 24(c) illustrate a security device according to an embodiment of the invention;

FIG. 25 schematically illustrates the visual effect exhibited by a security device according to a further embodiment of the invention;

FIGS. 26 to 30 schematically illustrate security devices according to further embodiments of the invention;

FIGS. 31(a) and 31(b) schematically illustrate an exemplary process for forming a focussing element array for use in embodiments of the invention;

FIGS. 32 and 33 schematically show two embodiments of apparatus for simultaneously applying a focussing element array and an array of image elements to a substrate, suitable for use in methods according to the invention;

FIG. 34 schematically shows an embodiment of apparatus for sequentially applying a focussing element array and an array of image elements to a substrate, suitable for use in embodiments of the present invention;

FIGS. 35, 36 and 37 show three exemplary security documents carrying security devices made in accordance with embodiments of the present invention (a) in plan view, and (b)/(c) in cross-section; and

FIG. 38 illustrates a further embodiment of a security document carrying a security device made in accordance with the present invention, (a) in front view, (b) in back view and (c) in cross-section.

### DETAILED DESCRIPTION

In the following description, the at least one excitation wavelength is at least one wavelength within the ultra-violet (UV) part of the electromagnetic spectrum, and for brevity illumination under the second illumination condition will be referred to as illumination under “UV light” or “UV illumination”. However, it will be appreciated that in variations of the invention, the at least one excitation wavelength may be at least one wavelength outside of the UV (and visible) part of the electromagnetic spectrum. Herein, when referring to the visual effects of the devices under illumination with UV light, the figures are representative of the parts of the device that exhibit a luminescent response.

The appended drawings use different shading/hatching patterns to represent different colours.

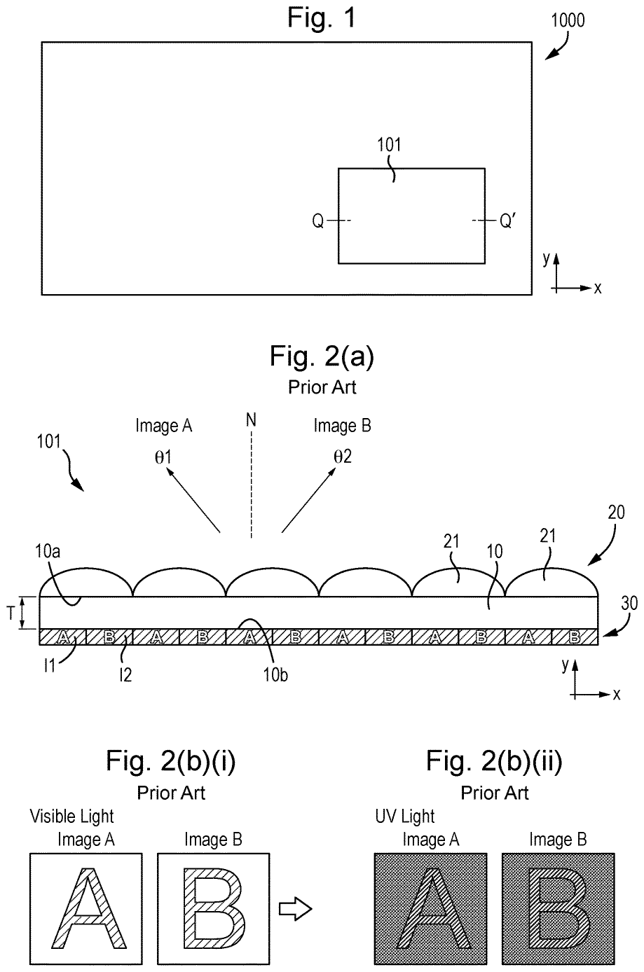

FIG. 1 schematically illustrates, in plan view, a security document 1000, here in the form of a banknote, carrying a conventional lenticular security device 101 known in the art. FIG. 2(a) illustrates a cross-sectional view of the device 101 along the line Q-Q′. The device 101 comprises a transparent substrate 10, which may or may not be the base substrate of the document. On a first side 10a of the substrate 10 there is disposed an array 20 of cylindrical lenses 21 that extend parallel to each other and into the plane of the page (i.e. along the y-axis). On the opposing side 10b of the substrate, the device 101 comprises an image array 30 comprising a plurality of image elements that form the images exhibited by the device. The thickness, T, of the substrate 10 substantially corresponds to the focal length of the lenses 21 such that the image array is formed substantially within the focal plane of the lens array 20. In this example, the image layer 30 is formed as a single image layer. The image array comprises a first set of image elements I₁ and a second set of image elements I₂ that are interleaved with each other periodically along the x-direction. The first image elements together define the first image (here in the form of the alphanumeric character “A” against a white background), and the second image elements together define a second image (here in the form of the alphanumeric character “B” against a white background). In this way, each set of image elements defines an image channel, such that in this example the device is a two-channel lenticular device. In this example, each image element is in the form of an elongate line element extending parallel with the direction of elongation of the cylindrical lenses (i.e. along the y-direction).

In the device 101, the image array 30 comprises a single blue ink that is present in both image channels. Therefore, when the device 101 is viewed under visible (preferably white) light, an observer of the device perceives the first image (“Image A”) in the form of a blue “A” at a first viewing angle θ1 (typically measured from the plane normal of the device, N) due to light from the first set of image elements I1 being directed to the viewer along that angle by the lens array. As the device is tilted such that the viewing angle changes to θ2, the viewer perceives the second image (“Image B”) in the form of a blue “B” due to light from the second set of image elements I2 being directed to the viewer. This optically variable “image switch” exhibited under visible light illumination is schematically illustrated in FIG. 2(b)(i).

The ink used to form the image array of device 101 does not contain any luminescent material. Consequently, when the device 101 is viewed under UV illumination, there is no luminescent response and the ink appears dark rather than exhibiting the visible blue colour seen under visible light. Thus, no optically variable effect is observed under UV illumination conditions, as schematically shown in FIG. 2(b)(ii).

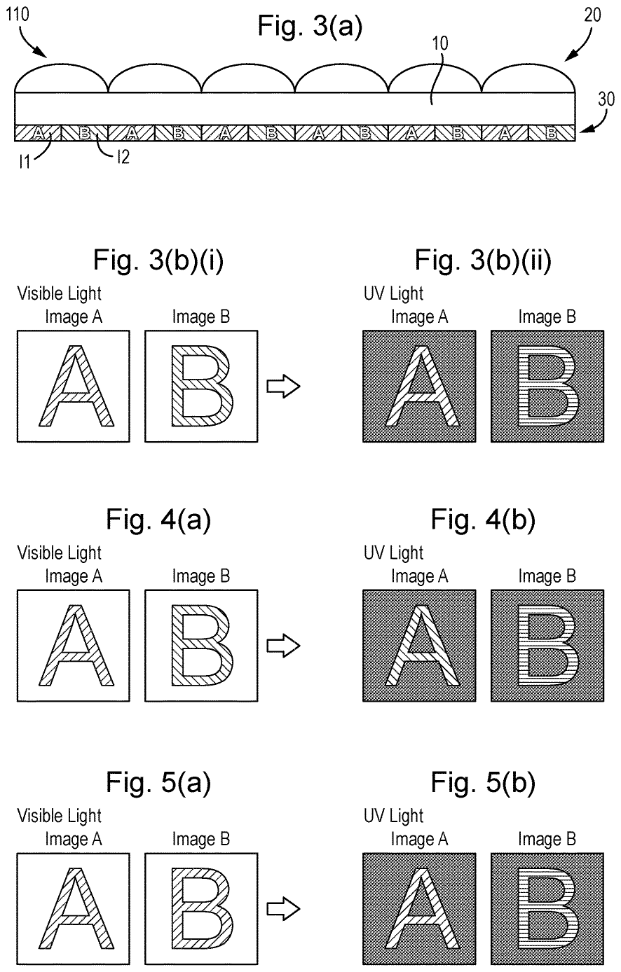

FIG. 3 schematically illustrates a security device 110 according to a first embodiment of the present invention. The construction of the device 110 is substantially the same as that described above with reference to FIG. 2; however, the inks used to form the image array 30 are configured to exhibit secure optical effects under both visible and UV illumination, as will now be described.

The image array 30 comprises a first ink and a second ink (an ink being a composition comprising a binder carrying appropriate dyes and/or pigments as necessary to exhibit the desired colour effects, of which examples will be given below), with the first ink exhibiting a blue colour under visible light and the second ink exhibiting a red colour under visible light. The first set of image elements I1 (labelled “A”) comprise the first ink but not the second ink, and the second set of image elements I2 (labelled “B”) comprise the second ink but not the first ink, as schematically illustrated in FIG. 3(a). The arrangement of the inks across the image elements of the image array 30 corresponds to that of the device 101 in FIG. 2, and consequently under illumination by visible light, the device 110 exhibits an optically variable image switch from a blue “A” to a red “B”, as shown in FIG. 3(b)(ii).

In the device 110 of FIG. 3, both the first and second inks comprise respective luminescent materials that respond to UV illumination so as to exhibit visible colours when the device is illuminated under UV light. In this example, the first ink luminesces to exhibit a blue colour and the second ink luminesces to exhibit a yellow colour. Consequently, under illumination by UV light, the device exhibits a different optically variable effect from that seen under visible light, with an image switch from a blue “A” to a yellow “B” being perceived upon tilting the device. This is schematically illustrated in FIG. 3(b)(ii).

Thus, in comparison to the conventional device described with reference to FIG. 2, the lenticular security device 110 according to an embodiment of the invention provides an enhanced level of security by exhibiting visible colours under both illumination conditions, and furthermore wherein the optical effects under the two illumination conditions are different. In this example, although the graphical forms of the images under visible light (i.e. an “A” switching to a “B”) are the same as those of the images exhibited under UV illumination, the colour change is different under the two illumination conditions. This change in optical effect may be considered to be a change in information content, and provides a particularly secure device that is difficult to counterfeit.

FIG. 4 schematically illustrates a variation of the device 110 shown in FIG. 3. In this embodiment, the first and second inks both change colour upon a change of illumination conditions from visible illumination to UV illumination. Here, the first ink exhibits a blue colour under visible illumination and a red colour under UV light; whereas the second ink is red under visible light and exhibits a yellow luminescent colour under UV illumination.

In the examples of FIG. 3 and FIG. 4, the colours exhibited by the first and second inks were different under each illumination condition. FIG. 5 schematically illustrates a device where the first and second inks exhibit substantially the same colour when viewed under visible light (here, blue), and exhibit different colours when illuminated under UV light (here blue and yellow respectively). Thus, when viewed under visible light, the device exhibits an image switch from a blue “A” to a blue “B” upon tilting (schematically shown in FIG. 5(a)), and when illuminated with UV light, exhibits an image switch from a blue “A” to a yellow “B” (schematically shown in FIG. 5(b)).

Such embodiments in which the two inks “match” in colour under visible light, and differ in colour when illuminated with UV illumination, advantageously provide a particularly distinct change in optical effect under upon a change in the illumination conditions, thereby increasing the ease of authentication whilst maintaining the difficulty of counterfeit. It is noted that although in this embodiment the first and second inks exhibit substantially the same colour when viewed under visible light and exhibit different colours under UV illumination, in alternative embodiments the first and second inks may exhibit different colours under visible illumination, and substantially the same colours when illuminated by UV light.

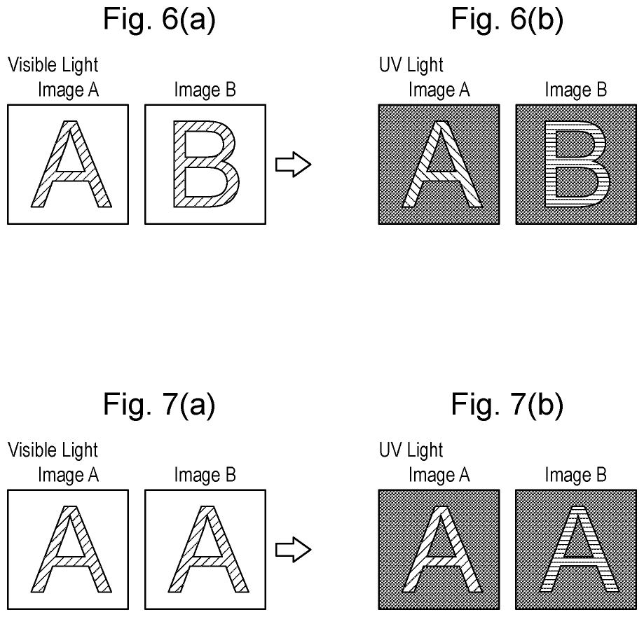

FIG. 6 illustrates a variation in which both the first and second inks change colour under a change in illumination conditions. In this example, both the first and second inks are blue under visible light (FIG. 6(a)), with the first ink appearing red and the second ink appearing yellow under UV light (FIG. 6(b)).

Thus far, we have considered embodiments in which both the first optical effect (exhibited under visible light) and the second optical effect (exhibited under UV light) are optically variable effects; in other words the images exhibited by the device change upon tilting. FIG. 7 schematically illustrates a security device according to a further embodiment of the invention in which the arrangement of the inks across the first and second image channels is in accordance with the alphanumerical character “A”. The same first and second inks are used as in the FIG. 5 embodiment, and consequently under visible light a blue letter “A” is perceived at both the first and second viewing angles. In other words, the image exhibited by the device does not appear to change upon tilting, as illustrated in FIG. 7(a). However, when the device is illuminated under UV light, the first and second inks exhibit the visible colours blue and yellow respectively, thereby generating the optically variable effect of a blue “A” changing to a yellow “A” as shown in FIG. 7(b). In this way, the optically variable effect exhibited by the device differs under the two illumination conditions.

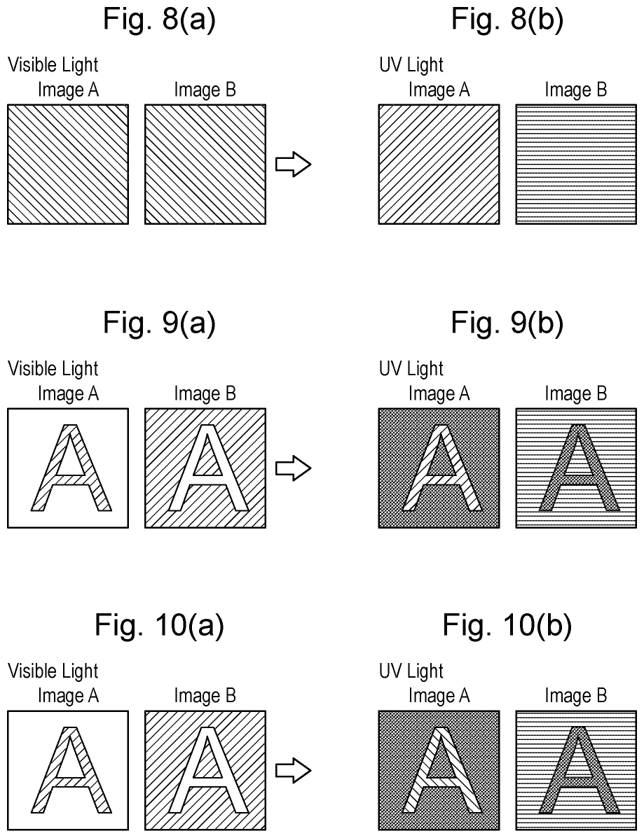

FIGS. 8, 9 and 10 schematically illustrate the visual effects of security devices according to further embodiments of the invention. In FIG. 8, each image is in the form of a uniform block colour, with the first and second inks matching in colour under visible light. In this embodiment, the second ink may be applied as a substantially uniform colour layer on or over the first ink, thereby forming the first and second sets of image elements of the image array. In FIGS. 9 and 10, the arrangement of the first and second inks in the respective first and second sets of image channels is in accordance with an optically variable “phase change” effect in visible light. In both FIGS. 9 and 10, the first and second inks both exhibit substantially the same blue colour under visible light. In FIG. 9, only the second ink changes colour upon a change to UV illumination, whereas in FIG. 10 both inks change colour.

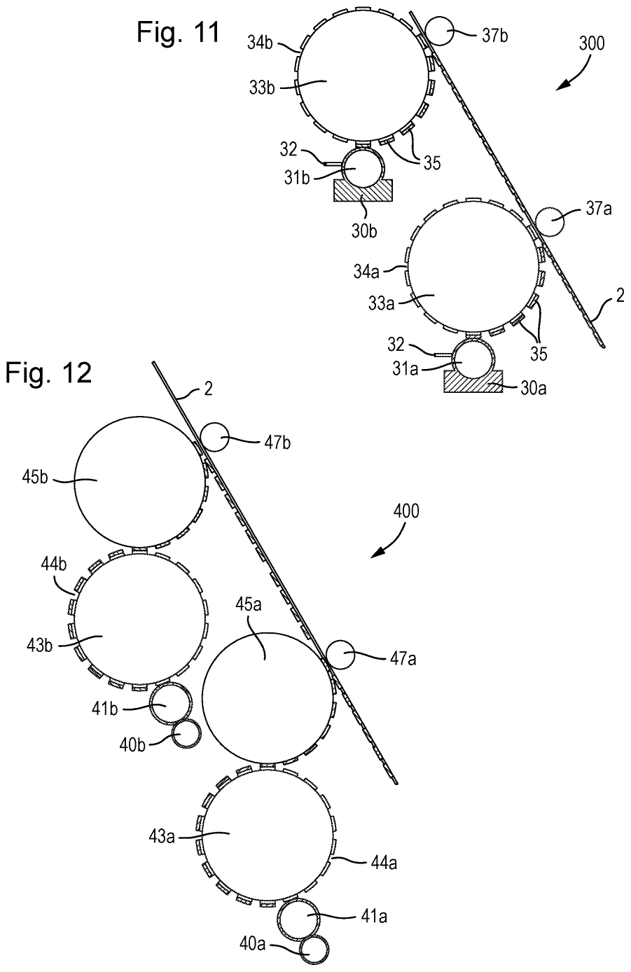

FIG. 11 schematically illustrates a first (flexographic) printing system 300 for forming the image array 30 of the security devices discussed thus far, in which the first image segments comprise the first ink and not the second ink, and the second image segments comprise the second ink but not the first ink. Each of the first and second inks is transferred from a respective printing plate 34a, 34b to the substrate 2. In this example, the substrate 2 is the substrate of a security article that is intended to be subsequently attached to or incorporated within a security document 1000, although in alternative embodiments the image array may be printed directly on to the substrate of the security document. Each printing plate 34a, 34b comprises raised ink receptive areas that correspond to the regions of the image array desired to contain the respective ink. The printing plates are coupled to the outer surface of rollers 33a, 33b respectively.

Referring to the first ink, ink from reservoir 30a is transferred to anilox roller 31a. Metering means such as plates 32 may be provided to control the applied ink weight. The ink from the anilox roller is then transferred to the printing plate 34a, in particular the ink receptive raised areas, before being transferred to the substrate 2 is it passes through a nip formed between the printing plate 34a and impression roller 37a. The corresponding process is carried out for the second ink. The rollers and printing plates are registered so that the image elements formed on the substrate 2 are interleaved in the desired manner.

FIG. 12 illustrates an alternative (lithographic) printing system 400 for forming the image arrays of the devices discussed thus far. In this process, the first ink is transferred from inking rollers 40a, 41a onto ink receptive raised elements of a printing plate 44a. The printing plate 44a is coupled to the outer surface of roller 43a. In this printing process, the ink is firstly transferred from the printing plate 43a to transfer roller 45a before being transferred to the substrate 2 at a nip formed between the transfer roller 45a and impression roller 47a. The corresponding process is carried out for the second ink, which is transferred to the substrate at a nip formed between the transfer roller 45b and impression roller 47b. The printing plates and the rollers are registered such that the first and second inks are printed on to the substrate in the desired register.

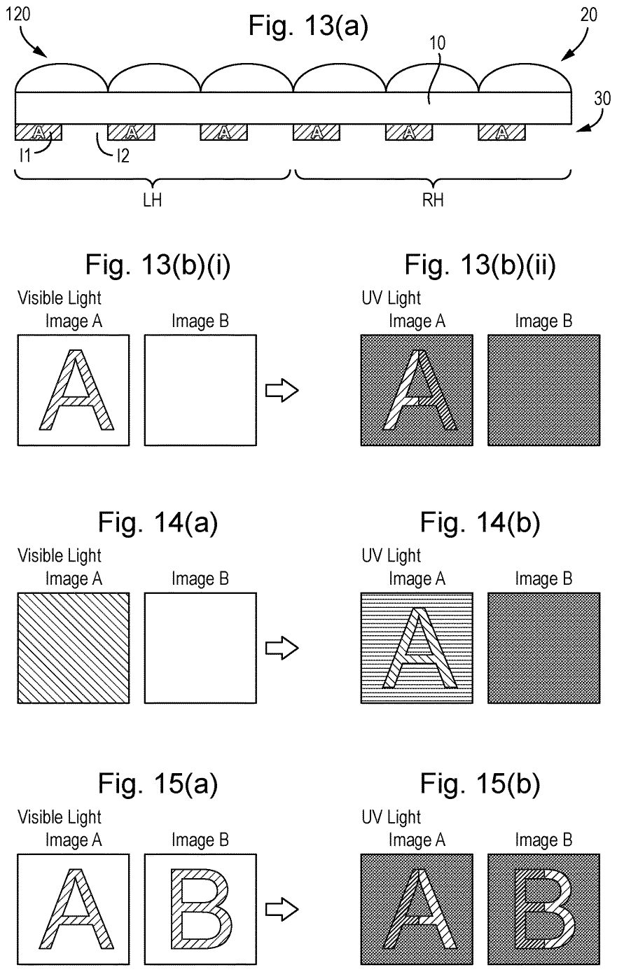

Thus far, the first set of image elements of the image array has comprised the first ink but not the second ink, and the second set of image elements of the image array has comprised the second ink but not the first ink. We now discuss devices in which both the first and second inks are present within the same set of image elements (same image channel). FIG. 13 schematically illustrates, in cross-sectional view, a security device 120 according to an embodiment of the invention. The construction of the device 120 is substantially the same as that of device 110 described above; however, the arrangement of the first and second inks in the image array differs as will now be described.

As schematically shown in FIG. 13(a), the second set of image elements I2 do not contain any ink or image forming material. In other words, the first set of image elements of the image array 30 are spaced by gap regions. In this example, the first image elements I1 contain both the first and second inks, which both appear blue under visible light. However, only the first ink comprises luminescent material, which luminesces blue under UV illumination. Under visible light, the device 120 exhibits a first image in the form of a blue “A” against a white background when viewed at the first range of viewing angles. At the second range of viewing angles, each lens of the lens array 20 directs light from the gap regions 12 (the second set of image elements) such that the device appears blank, which effectively constitutes a second image. Thus, upon tilting from the first range of viewing angles to the second range of viewing angles, the device exhibits an optically variable appearance in which the image of the blue “A” appears to “flash” on and off. This effect is schematically illustrated in FIG. 13(b).

Under UV illumination, only the regions of the first image elements I1 that contain the first ink exhibit a visible colour. In this example, the left half (LH) of the image array comprises the first ink (but not the second ink) and the right half (RH) of the image array comprises the second ink (but not the first ink). Therefore, under UV light only the left half of the “A” exhibits a visible colour, as shown in FIG. 13(c). In this way, the graphical form of the image exhibited at the first range of viewing angles is different under UV illumination compared to under visible light. The optically variable effect under UV illumination remains an “on/off” effect, with the device appearing blank at the second range of viewing angles.

FIG. 14 schematically illustrates a further example of a security device according to an embodiment of the invention. In this case, the optically variable effect exhibited by the device is an “on/off” effect under both visible and UV illumination, in the same manner as described in FIG. 13. Here, both the first and second inks appear the same red colour under visible light such that at the first range of viewing angles the device appears as a uniform red colour shown in FIG. 14(a). Both the first and second inks contain luminescent material, with the first ink exhibiting a red colour and the second ink exhibiting a yellow colour under UV illumination. The first ink is printed as in the form of a letter “A” across the first set of image elements, with the second ink printed as the background across the first set of image elements. Consequently, under UV illumination the device exhibits a red “A” against a yellow background at the range of viewing angles corresponding to the first set of image elements.

FIG. 15 schematically illustrates an embodiment according to the invention in which the first and second sets of image elements each contain both the first ink and the second ink. Here, the first set of image elements I1 together form the image of the alphanumeric character “A” against a blank background, and the second set of image elements I2 together form the image of the alphanumeric character “B” against a blank background. As in the example described in FIG. 13, both the first and second inks appear substantially the same colour (blue) under visible light, with only one of the inks containing a luminescent material. In this case, the non-luminescent (first) ink is printed only across the left hand side (LH) of the image array, and the luminescent (second) ink is printed only across the right hand side (RH) of the image array. Consequently, under UV illumination, only the right hand sides of the “A” and the “B” exhibit a visible colour, thereby changing the graphical form of the exhibited images under the second illumination condition.

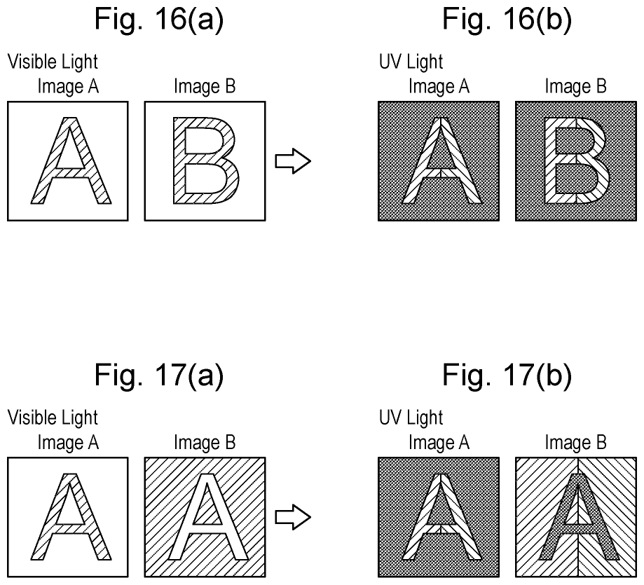

FIGS. 16 and 17 illustrate similar examples in which the first ink is printed only on the left hand side of the image array and the second ink is printed only on the right hand side. In the examples of FIGS. 16 and 17, both the first and second inks contain luminescent material such that both inks exhibit a visible colour (blue and red respectively) under UV illumination.

The image arrays of the devices 120 discussed above in FIGS. 13 to 17 can be formed using techniques described in WO2017/081447 or WO2019/063961. WO2019/063961 describes a method for blending image materials (e.g. inks) of different colour such that a gradual change in colour is exhibited across the resulting layer. The blended inks can then be used to form an image array that exhibits a gradual colour change at the scale of the image elements.

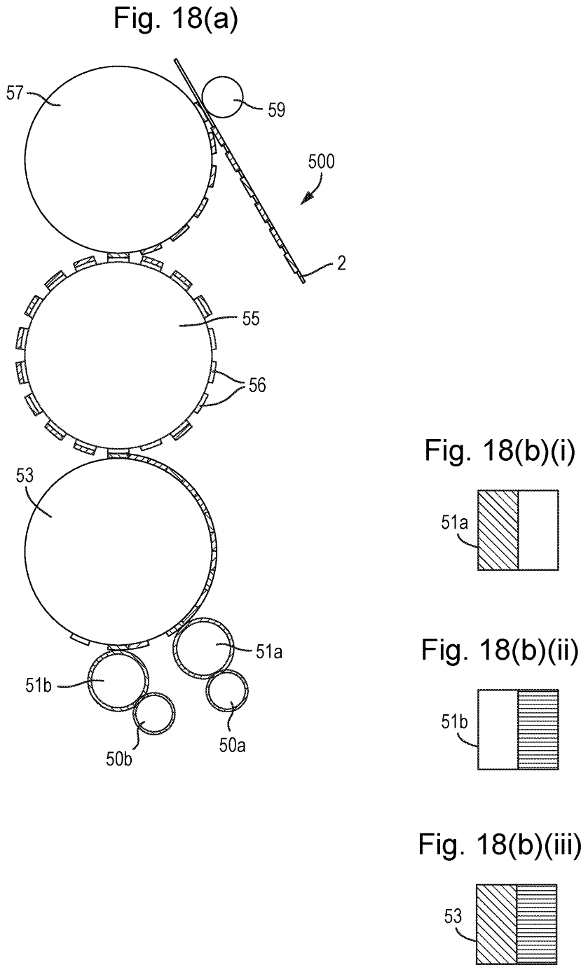

FIG. 18 schematically illustrates one example printing system 500 that can be used to form the image arrays of such devices. The first and second inks are provided, via respective rollers 50a, 50b, to patterned ink application rollers 51a, 51b. Roller 51a carries the macro pattern corresponding to the first ink and roller 51b carries the macro pattern corresponding to the second ink. The patterned ink application rollers 51a, 51b may be patterned anilox or gravure rollers for example. In this example, the first ink is desired to cover the left hand side of the image array and the second ink is desired to cover the right hand side of the image array (e.g. as in FIG. 13), although different macro arrangements of the two inks are envisaged, such as that of the device shown in FIG. 14. The macro patterns of the ink application rollers are schematically illustrated in FIGS. 18(b)(i) and 18(b)(ii). In other examples, the macro arrangements of the inks may be “blended” using the techniques of WO2019/063961.

The two inks are then transferred to transfer blanket/roller or other collection surface 53, which therefore carries the complete macro arrangement of the first and second inks, as schematically shown in FIG. 18(b)(iii). The inks are then transferred from the transfer blanket/roller 53 to production tool 55, which carries a surface pattern in the form of a surface relief structure. The elevations 56 of the surface relief structure form ink receptive areas that correspond to the desired image element pattern of the image array. For example, referring to the device of FIG. 13, the elevations 56 of the surface relief correspond to the pattern forming the letter “A”. The inks therefore adhere to the elevations 56 of the production tool but not to the depressions in between.

In the example printing arrangement of FIG. 18(a), the production tool 55 is brought into contact with a further transfer blanket 57, from which the inks are applied to substrate 2 using impression roller 59.

A combination of the printing techniques described in FIGS. 11 and 12, with those described in FIG. 18 (and/or in WO2017/081447 or WO2019/063961), can be used to form security devices that exhibit particularly complex effects under a change in illumination conditions. FIG. 19 schematically illustrates an example printing system 600 that can be used to form image arrays of further devices according to the invention. The arrangement depicted within bounding box 60 is substantially identical to the printing system 500 described above with reference to FIG. 18, and constitutes a first printing subsystem. The printing system 600 comprises a second printing subsystem shown generally at 80. The production tool 55 of the first subsystem carries a surface relief that corresponds to the desired pattern of the first set of image elements, and the production tool 73 of the second subsystem carries a surface relief that corresponds to the second set of image elements. The two production tools 55, 75 are registered such that ink is transferred from the production tools to the substrate 2 via transfer blanket/roller 57 in register in accordance with the interleaved first and second sets of image elements.

In first subsystem 60, first and second inks are applied, via patterned ink application rollers 51a, 51b, to transfer blanket 53, which therefore carries the macro arrangement of the first and second inks across the first set of image elements. In a corresponding manner, in the second subsystem 80, third and fourth inks are applied, via patterned ink application rollers 71a, 71b, to transfer blanket 73 which therefore carries the macro arrangement of the third and fourth inks across the second set of image elements. In this example, two inks are applied for each set of image elements of the desired image array; however, the same techniques may be applied if only one ink, or if three (or more) inks are desired for a particular set of image elements, for example to provide an RGB or CMYK colour image.

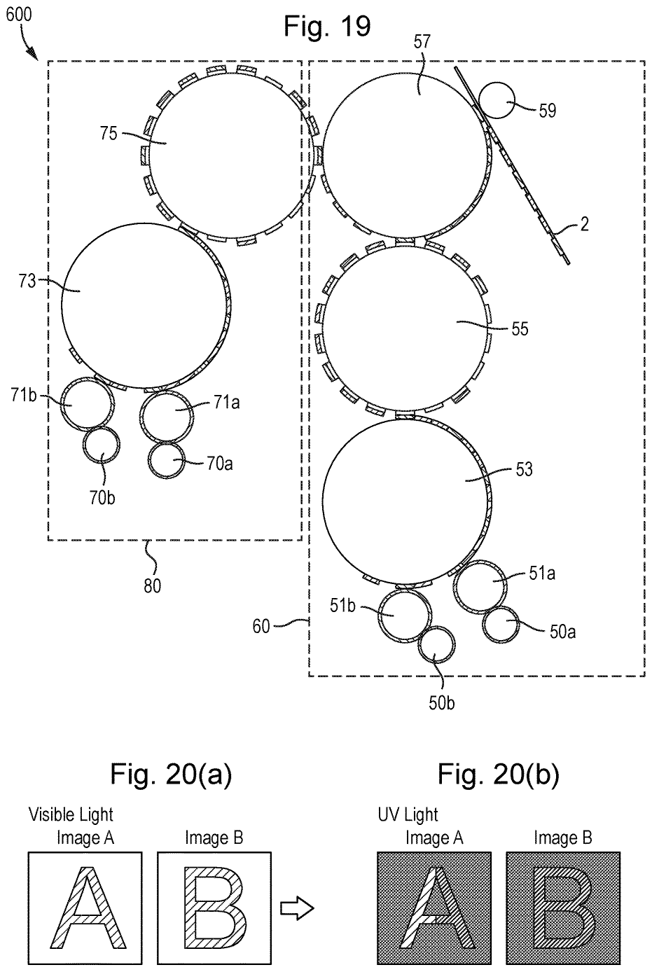

Examples of devices comprising an image array formed in accordance with the printing system 600 of FIG. 19 will now be described with reference to FIGS. 20 to 23.

In FIG. 20, the first set of image elements (corresponding to Image A) comprises a first ink applied across the left half of the image array and a second ink applied across the right half. The second set of image elements (corresponding to Image B) comprises only the second ink. Both the first ink and the second ink exhibit the same visible colour (blue) under visible light, with only the first ink containing a luminescent material (in this case exhibiting a visible luminescent blue colour under UV irradiation). Consequently, under visible light, an image switch from a blue “A” to a blue “B” is exhibited upon tilting the device. Upon a change in illumination conditions to UV light, the exhibited optically variable effect changes to an “on/off” effect, with only the left hand side of the letter “A” exhibiting a luminescent blue colour (i.e. exhibiting a change in graphical form).

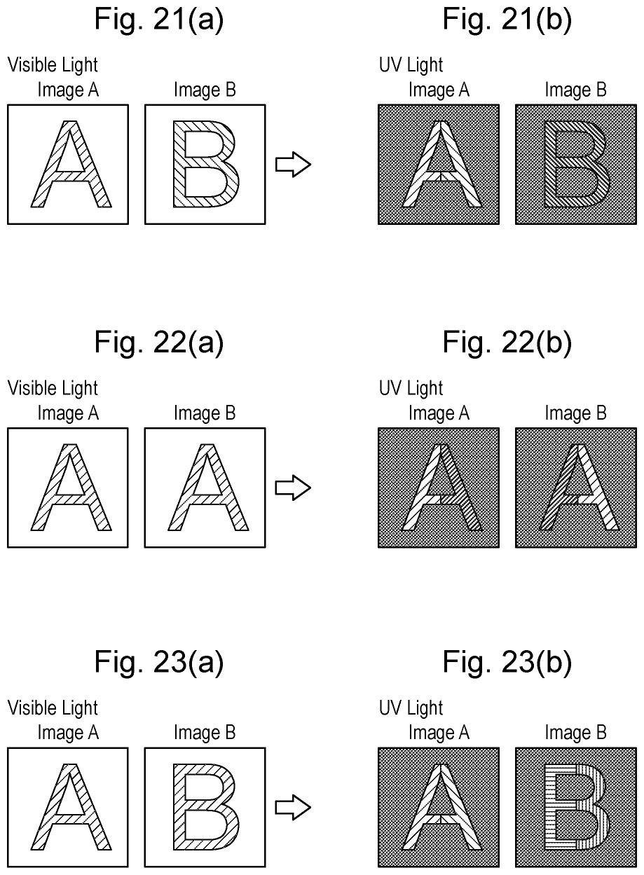

In a device as depicted in FIG. 21, the image array comprises three different inks. The first set of image elements comprises a first ink applied only across the left hand side of the array and a second ink applied only across the right hand side of the image array. The second set of image elements comprises only a third ink. Both the first and second inks exhibit substantially the same blue colour under visible light, with the first ink luminescing blue under UV light and the second ink luminescing red. The second ink appears red in visible light and does not contain any luminescent material.

In a device as depicted in FIG. 22, the same two inks are used to form both the first and second sets of image elements. The first set of image elements comprises the first ink (blue in visible, blue in UV) across the left hand side of the image array only, and the second ink (blue in visible, non-responsive in UV) across the right hand side of the array only. The macro arrangement of the first and second inks is reversed in the second set of image elements compared to the first set of image elements, giving rise to the change in optical effect under a change in illumination conditions as illustrated in FIG. 22.

FIG. 23 schematically illustrates a device according to a further embodiment of the invention, in which four different inks are used. In this case, all four inks exhibit the same (blue) visible colour in visible light such that a viewer of the device perceives an image switch effect from a blue “A” to a blue “B”. Under UV illumination, each ink exhibits a different visible colour (blue, red, yellow and green respectively), giving rise to a particularly complex (and therefore secure) change in optical effect when the device is viewed under the different illumination conditions.

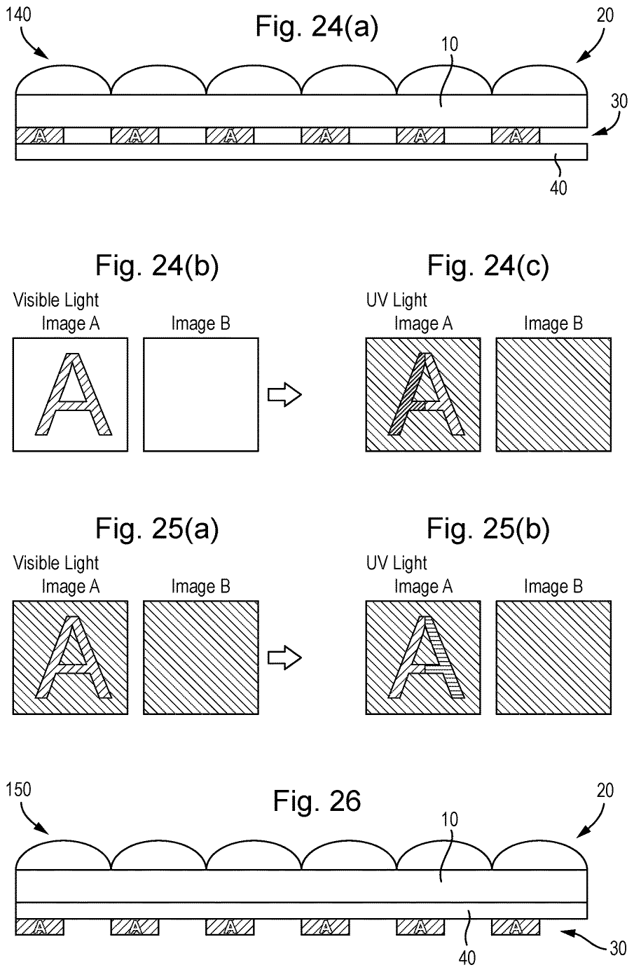

FIG. 24(a) schematically illustrates, in cross-section, a security device 140 according to a further embodiment of the invention. The device has a similar construction to the device 120 described above with reference to FIG. 13, with the first image elements of the image array comprising first and second (opaque) inks arranged so as to provide different optical effects under visible and UV illumination. The device 140 further comprises a cover layer 40 applied so as to uniformly extend over the image array on a distal side of the image array 30 relative to the lens array 20. In this example, the cover layer 40 comprises a luminescent ink that is substantially colourless and transparent in visible light, and exhibits a visible red colour under UV illumination. The cover layer 40 is visible in the gaps between the image elements of the image array 30. Consequently, the background colour of the images appears to change colour from colourless in visible light to red in UV light.

FIG. 25 illustrates a similar example in which the both the first and second inks of the image array 30 exhibit visible colours under UV illumination (here, blue and yellow respectively), and the cover layer exhibits a visible red colour under both visible and UV illumination conditions. In practice the cover layer could be formed by applying it over the finished image array 30, e.g. by printing. Alternatively, the cover layer could be provided on another substrate (not shown) which is then adhered to the image array 30. The cover layer 40 may be at least partially transparent (e.g. translucent) or opaque.

A similar visual effect can be achieved by applying the cover layer on the same side of the image array 30 as the lens array 20, as schematically illustrated in the device 150 shown in FIG. 26. In such embodiments, it will be appreciated that the cover layer 40 is required to be at least partially transparent under both illumination conditions in order that the image array 30 is visible through the lens array 20.

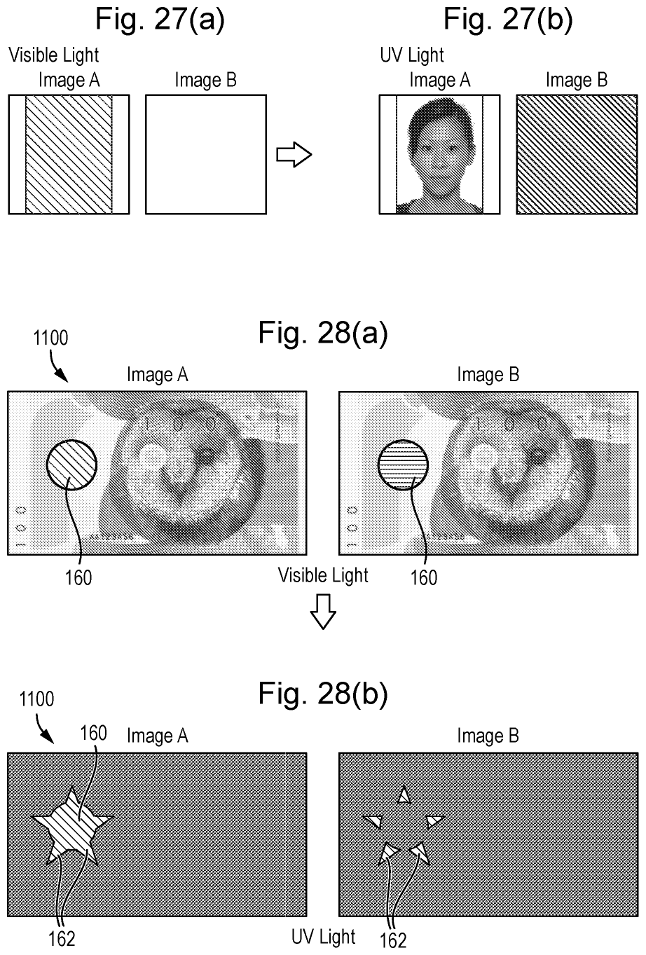

The same principles described above can be used to form full-colour (e.g. CMYK or RGB) colour images under at least one of the illumination conditions. Such an example is schematically illustrated in FIG. 27. Here, the first set of image elements comprises four different inks that each exhibit substantially the same red colour under illumination by visible light, and the second set of image elements define gap regions between the first set of image elements. Under UV illumination, the four inks exhibit cyan, magenta, yellow and black respectively, with the four inks being arranged in accordance with a full colour portrait image. Thus, as illustrated in FIG. 27(a), the device exhibits an “on/off” switch effect between a uniform red image at the first range of viewing angles, and a “blank” image at the second range of viewing angles. Upon illumination by UV light, a full-colour portrait is exhibited at the first range of viewing angles, which is perceived to disappear as the device is tilted to the second range of viewing angles.

FIG. 28 schematically illustrates a security document 1100 according to an embodiment of the invention, here in the form of a polymer banknote (although in alternative embodiments the banknote could be a paper banknote or a hybrid of paper and polymer). The banknote carries a security device 160 according to an embodiment of the invention. The banknote also carries a plurality of print workings (here, in the form of the note denomination and an image of an owl as illustrated) in addition to the security device 160. In this embodiment, the image array of the device comprises a first set of image elements comprising a first ink that exhibits a red non-luminescent visible colour under the first illumination condition, and which exhibits a red visible colour under the second illumination condition. The second set of image elements comprises a second ink, different from the first, with the second ink exhibiting a yellow non-luminescent visible colour under the first illumination condition, and which does not luminesce under the second illumination condition. Both the first and second inks are arranged in accordance with a circular geometric shape. Consequently, under the first illumination condition (shown in FIG. 28(a)), the device 160 exhibits a red circle changing to a yellow circle in substantially the same lateral position on the bankote upon tilting. When illuminated with the second illumination condition, the device exhibits, in the same relative position, a red circle changing to a non-luminescing circle.

In this embodiment, the device further comprises a static print working comprising a third ink which under the first illumination conditions is substantially colourless, and under the second illumination conditions exhibits a visible colour (here, red). By “static” print working, we mean that the print working does not exhibit an optically variable effect upon tilting the device. The static print working is typically provided outside of the lateral footprint of the array of lenses. In this embodiment, the static print is arranged so as to define five circumferentially spaced points of a star, as seen at 162 in FIG. 28(b). In this way, the visual appearance of the device 160 dramatically alters under the change in illumination conditions, with the static print working complementing the luminescent first ink of the first set of image elements to form a combined image of a “complete” a star indicium at the first range of viewing angles (i.e. the red circle exhibited by the first set of image elements in combination with the points of the star defined by the static print working) when the device is illuminated with the second illumination condition.

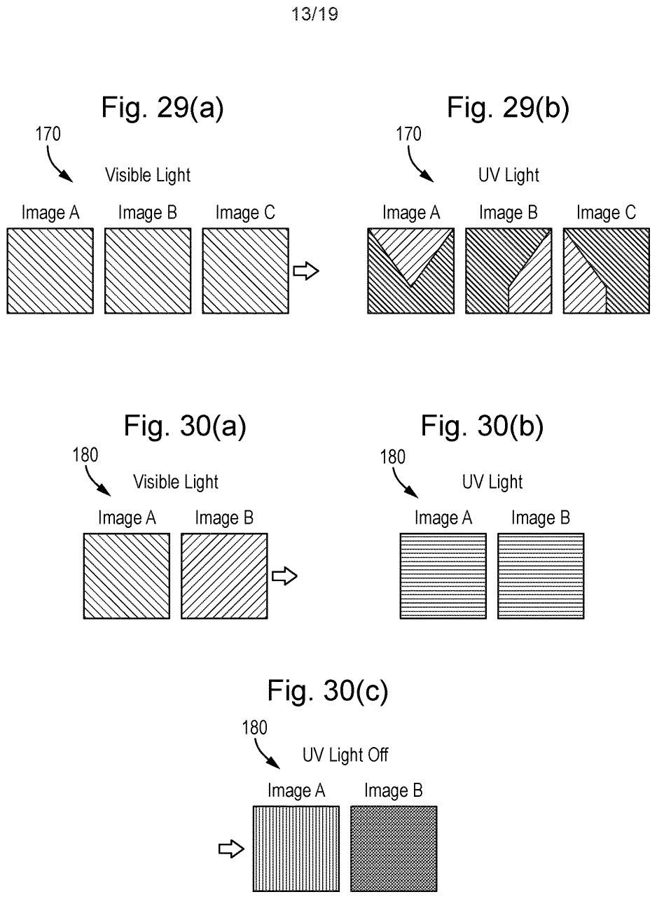

Thus far, we have considered devices in which the image array comprises first and second sets of image elements so as to exhibit an “image switch” optically variable effect upon a change of viewing angles, when illuminated with at least one of the viewing conditions. FIG. 29 schematically illustrates the visual appearance of a device 170 according to one embodiment of the invention, in which the image array comprises first, second and third interlaced sets of image elements. The image array comprises a first ink and a second ink. Both the first and second inks exhibit substantially the same non-luminescent visible colour (here, red) when viewed in visible light. Under UV illumination, the first ink exhibits a blue visible colour, whereas the second ink is non-luminescent. The arrangement of the first ink across the image array is such that, when illuminated with UV illumination, the first set of image elements cooperate to exhibit Image A, the second set of image elements cooperate to exhibit Image B, and the third set of image elements cooperate to exhibit Image C, with Images A, B and C forming an animation sequence as shown in FIG. 29(c). In this way, under the second illumination conditions, as the device is tilted so as to be viewed at the viewing angles corresponding to Images A, B and C, an animation effect is perceived as illustrated in FIG. 29(c) with a blue shape appearing to move in a clockwise manner against a non-luminescent background as the viewing angle is changed.

In some embodiments, the animation sequence may comprise four or more frames (i.e. the image array comprises four or more sets of image segments). It is also envisaged that the arrangement of the first and second (and possibly further) inks may be such that the device exhibits an animation effect when viewed under both the first illumination conditions and the second illumination conditions.

FIG. 30 schematically illustrates the visual effect exhibited by a security device 180 according to a further embodiment of the present invention. The image array of device 180 is formed of first and second sets of image elements, and comprises first and second inks. The first set of image elements comprises the first ink and not the second ink, and the second set of image elements comprises the second ink and not the first ink. In this example, the first and second inks exhibit different non-luminescent visible colours under the first illumination conditions (in this example, red and blue respectively), and substantially the same visible colour (here, yellow) when illuminated with UV light. In this embodiment, the first ink comprises, in addition to a fluorescent material that luminesces yellow, a phosphorescent material that luminesces green such that the device continues to exhibit a luminescent green colour as a result of the UV excitation, after the UV illumination has been removed. In this way, the phosphorescent response is only seen at the first range of viewing angles (Image A).

In order for the desired optically variable effects to be exhibited, the image elements of the image array must be correctly located within the optical footprints of the focussing elements. Hence, each image element must be narrower than the pitch of the viewing element array 20, which is typically no more than 100 microns, usually less. For example, if the diameter of the viewing elements is 30 μm then each image element may be around 15 μm wide or less.

The viewing elements 21 can be formed via any convenient process including embossing or printing. However, cast-curing is most preferred. Suitable apparatus, materials and methods for forming relief structures defining the array of focussing elements disclosed herein are described in WO-A-2018/153840 and WO-A-2017/009616. In particular, the focussing elements can be formed by the in-line casting devices detailed in WO-A-2018/153840 (e.g. that designated 80 in FIG. 4 thereof), using an embossing tool 85 carrying an appropriately designed micro-optical structure from which can be cast the desired focussing element array shape. Similarly, the cast-curing apparatuses and methods disclosed in section 2.1 of WO-A-2017/009616 (e.g. in FIGS. 4 to 8 thereof) can also be used to form the presently disclosed relief structures.

Whichever casting apparatus is used, the curable material(s) from which the relief structure is cast may be applied either directly to the tool carrying the desired relief shape (e.g. to the embossing tool 85 of WO-A-2018/153840 or to the casting tool 220 of WO-A-2017/009616), or the curable material(s) may be applied directly to the substrate on which the relief structure is to be formed, and then brought into contact with the tool (e.g. by impressing the tool onto the deposited curable material). Both options are described in the aforementioned documents. Preferably, the latter option is employed and the curable material(s) are applied to the substrate by screen printing as detailed in WO-A-2018/153840, before being formed into the desired relief structure. If the former option is employed, it should be noted that there is preferably no wiping of the casting tool surface relief between applying the curable material to it, and bringing it into contact with the substrate, so that a base layer of curable material remains connecting the focussing elements together on the substrate.

Suitable curable materials are disclosed in WO-A-2017/009616, section 2.1. UV-curable materials are most preferred. Curing of the material(s) preferably takes place while the casting tool is in contact with the curable material, against the substrate. The radiation used to effect curing will typically be UV radiation but could comprise electron beam, visible, or even infra-red or higher wavelength radiation, depending upon the material, its absorbance and the process used. Examples of suitable curable materials include UV curable acrylic based clear embossing lacquers, or those based on other compounds such as nitro-cellulose. A suitable UV curable lacquer is the product UVF-203 from Kingfisher Ink Limited or photopolymer NOA61 available from Norland Products. Inc, New Jersey.

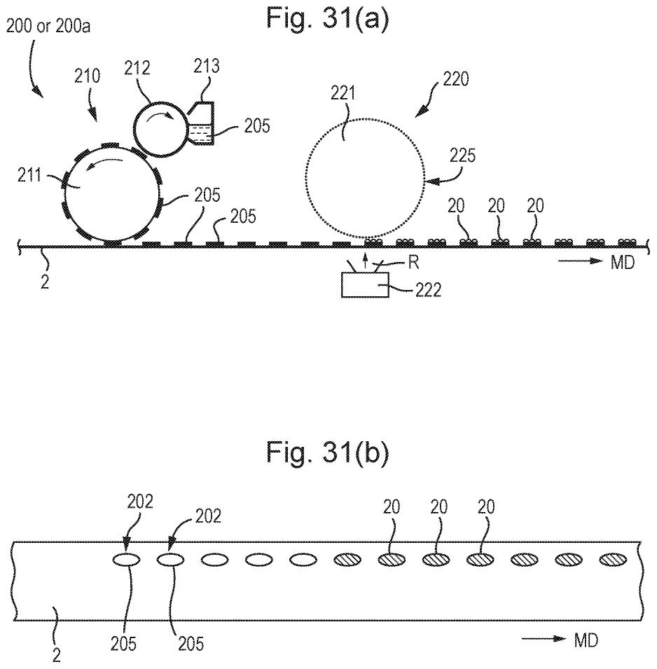

An example of a suitable cast-cure process for forming focussing element arrays 20 suitable for use in the security document disclosed herein will be described with reference to FIGS. 31(a) and(b) hereto, which show the focussing element array 20 only schematically. The process is shown as applied to a substrate 2 (which may be in the form of a web or a sheet, depending on application). FIG. 31(a) depicts the apparatus from a side view, and FIG. 31(b) shows the substrate 2 in a perspective view, the manufacturing apparatus itself being removed for clarity.

A transparent curable material 205 is first applied to the substrate 2 using an application module 210 which here comprises a patterned print cylinder 211 which is supplied with the curable material from a doctor chamber 213 via an intermediate roller 212. For example, the components shown could form part of a flexographic printing system. Other printing techniques such as lithographic, screen, or gravure printing could also be used. Print processes such as these are preferred since the curable material 205 can then be laid down on the substrate 2 only in selected regions 202 thereof, the size, shape and location of which can be selected by control of the print process, e.g. through appropriate configuration of the pattern on cylinder 211. However, in other cases, an all over coating method could be used, e.g. if the focussing element array 20 is to be formed all over the substrate 2. The curable material 205 is applied to the substrate 2 in an uncured (or at least not fully cured) state and therefore may be fluid or a formable solid.

The substrate 2 is then conveyed to a casting module 220 which here comprises a casting tool 221 in the form of a cylinder carrying a surface relief 225 defining the shape of the focussing element array 20 which is to be cast into the curable material 205. As each region 202 of curable material 205 comes into contact with the cylinder 221, the curable material 205 fills a corresponding region of the relief structure, forming the surface of the curable material into the shape defined by the relief. The cylinder 221 may be configured such that the relief structure 225 is only provided at regions corresponding to shape and position of the first regions 202 of curable material 205.

Having been formed into the desired focussing element array shape (e.g. an array of cylindrical lenses), the curable material 205 is cured by exposing it to appropriate curing energy such as radiation R from a source 222. This preferably takes place while the curable material is in contact with the surface relief 225 although if the material is already sufficiently viscous this could be performed after separation. In the example shown, the material is irradiated through the substrate 2 although the source 222 could alternatively be positioned above the substrate 2, e.g. inside cylinder 221 if the cylinder is formed from a suitable transparent material such as quartz. In an alternative embodiment, the curable material 205 could be applied directly onto casting tool 221 rather than on to the substrate 2. This could be done in an all-over or patternwise manner.

In all embodiments of the invention, the image array can be applied to the substrate 2 using the techniques outlined herein with reference to FIGS. 11, 12, 18 and 19, depending on the desired optical effect to be achieved. The print systems for forming the image array of the device may be disposed downstream of the above-described casting apparatus, but alternatively could be located upstream, or at substantially the same point along the machine direction as explained below.

It is highly desirable for the focussing element array 20 and image element array 30 to be applied to the opposite surfaces of the substrate simultaneously. That is, at the same position along the transport path in the machine direction. This makes it possible to achieve the highest registration between the two components. WO-A-2018/153840 (e.g. FIG. 7 thereof) shows suitable apparatus for achieving this.

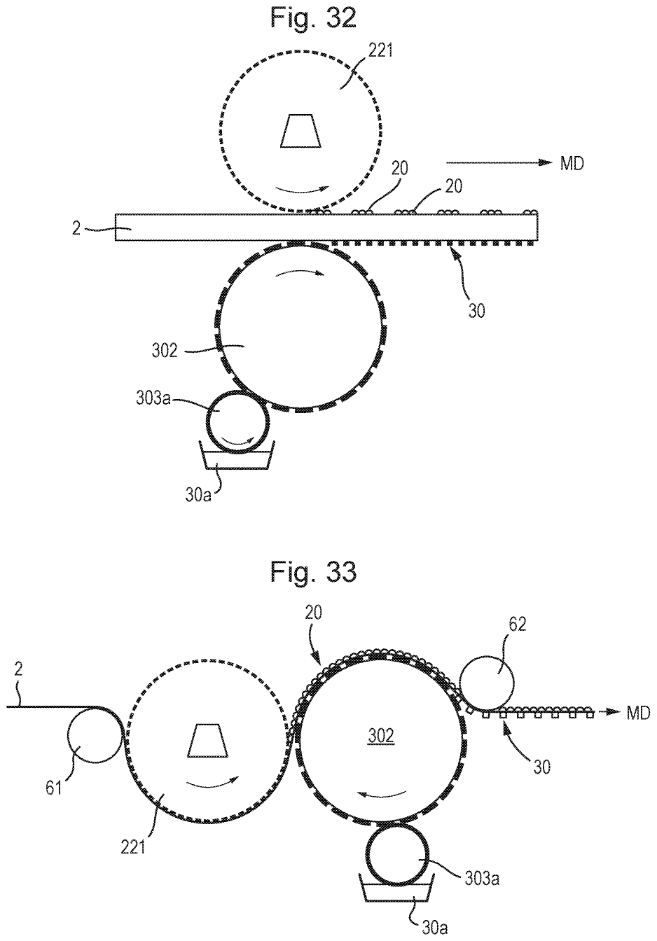

FIG. 32 hereto shows a schematic example of this in the case where the focussing element array 20 and image array 30 are applied to the first and second surfaces, respectively, of a substrate 2 (which may be a web or a sheet). The focussing element array 20 and image array 30 can be formed using any of the processes described above. For clarity, FIG. 32 depicts only selected components of the apparatus used to form focussing element array 20 and image element array 30, namely a casting tool 221 (e.g. as shown in FIG. 31) and print roller 302, which is supplied with ink 30a via an inking roller 303a. Other components of the process line are not shown. The curable material(s) may be applied on to the substrate 2 upstream of the casting tool 221 or directly onto the casting tool 221. The casting tool 221 and print roller 302 are arranged on opposite sides of the transport path along which the substrate 2 is conveyed, so as to form a (low pressure) nip through which the substrate 2 passes. At each location along the substrate 2, its first surface therefore comes into contact with the casting tool 221 at the same time as its second surface comes into contact with the print roller 302. As a result, the focussing element array 20 and image array 30 are formed on each point of the substrate simultaneously.

This has the significant advantage that any deformation experienced by the substrate 2, as a result of changes in processing temperature or the like, will be exactly the same when the focussing element array 20 is applied to the substrate 2 as it is when the image array 30 is applied. The substrate 2 has no time to expand or contract between the instant at which the focussing element array 20 is applied and when the image array 30 is applied, since they occur at the same time. As such, a very high degree of register between the two components is automatically achieved.

The arrangement shown in FIG. 32 has the disadvantage that since the nip between the casting tool 221 and the print roller 302 constitutes the first point of contact between the substrate and the casting tool 221, the transparent curable material 205 from which the focussing element array 20 is formed will be substantially uncured when it enters the nip. As such, the pressure applied between the casting tool 221 and the print roller 302 should be low so as to avoid damage to the cast focussing elements 20.

FIG. 33 shows an improved arrangement in which formation of the focussing element array 20 and application of the image array 30 can still be considered simultaneous because the curable material 205 is still in contact with the surface relief on casting tool 221 at the nip location between the casting tool 221 and the print roller 302. The curable material(s) may be applied on to the substrate 2 upstream of the casting tool 221 or directly onto the casting tool 221. The substrate 2 is wrapped around a portion of the casting tool 221 from a first point on roller 61, at which casting of the focussing element array 20 begins, until the nip with print roller 302 at which point the focussing element array 20 will be relatively well cured, preferably fully cured. As such, the pressure between the two components 221, 302 can be increased relative to that in the FIG. 32 embodiment since the material 205 is relatively hard and less prone to damage. This improves the quality achieved in the image element array 20 formation process. A further benefit of the arrangement shown is the increased wrap length of the substrate 2 around print roller 302, allowing for prolonged curing here also. The substrate 2 stays in contact with print roller 302 from the nip location until take-off roller 62.

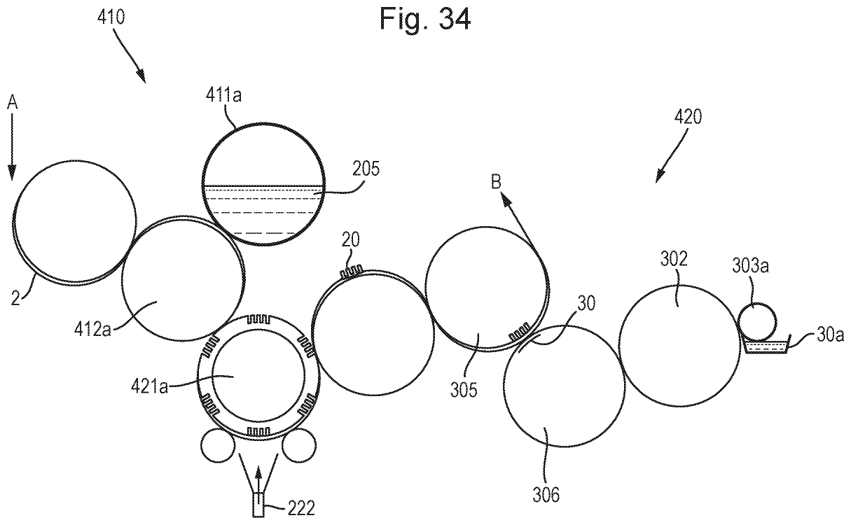

Simultaneous application of the focussing element array 20 and image array 30 is preferred but not essential. FIG. 34 illustrates an exemplary arrangement for sequentially (rather than simultaneously) applying the two components 20, 30 on opposing sides of a substrate 2 (which here is in the form of a sheet). This may be described as forming the two components in-line in the same pass. The arrangement generally comprises a print and cast module 410 for forming the focussing elements 20 and a print station 420. The substrate 2 enters the apparatus at arrow A and exits at arrow B. A curable material 205 is first applied to a first side of the sheet substrate 2 as it passes through a nip formed by screen print cylinder 411a and intermediate roller 412a. However, as previously discussed, other printing techniques such as lithographic, flexographic, offset or inkjet printing could also be used. The sheet 2 is then conveyed to casting tool 421a in the form of a cylinder defining the shape of a surface relief structure which is to be cast into the curable material 205 (e.g. an array of cylindrical lenses). Having been formed (shaped) into the desired surface relief structure defining the focussing element array 20, the curable material 205 is cured by exposing it to appropriate curing energy such as UV radiation from source 222. This preferably takes place while the curable material is in contact with the surface relief 225 although if the material is already sufficiently viscous this could be performed after separation.

The sheet substrate 2, now carrying the cured focussing element array 20, is then conveyed to the print station 420. In this example, the print station 420 is a lithographic print apparatus, comprising a patterned print cylinder 302 which is selectively supplied with an ink 30a via an inking roller 303a. The sets of image elements are transferred from print cylinder 302 to a blanket roller 306 and then onto the substrate 2 at a nip between blanket roller 306 and an impression roller 305. The substrate 2, now carrying both the focussing element array 20 and the image element array 30 on opposite sides is then conveyed away from the print module 420 via at arrow B.

Whilst in the above preferred examples, the image elements are print elements comprising a material having the required appearance characteristics, the image elements can be implemented in any way that achieves the desired appearance. One method which has been put forward as an alternative to the printing techniques mentioned above, and can be employed in embodiments of the invention, is used in the so-called Unison Motion™ product by Nanoventions Holdings LLC, as mentioned for example in WO-A-2005052650. This involves creating image elements (“icon elements”) as recesses in a substrate surface before spreading ink over the surface and then scraping off excess ink with a doctor blade. The resulting inked recesses can be produced with line widths of the order of 2 μm to 3 μm.

A different method of producing a high-resolution image array is disclosed in WO-A-2015/044671 and is based on flexographic printing techniques. A curable material is placed on raised portions of a die form only, and brought into contact with a support layer preferably over an extended distance. The material is cured either whilst the die form and support layer remain in contact and/or after separation. This process has been found to be capable of achieving high resolution and is therefore advantageous for use in forming the image array 30 in the present application.

Some more particularly preferred methods for the image array 30 on a substrate are known from US 2009/0297805 A1 and WO 2011/102800 A1. These disclose methods of forming micropatterns in which a die form or matrix is provided whose surface comprises a plurality of recesses. The recesses are filled with a curable material, a treated substrate layer is made to cover the recesses of the matrix, the material is cured to fix it to the treated surface of the substrate layer, and the material is removed from the recesses by separating the substrate layer from the matrix.

Another method of forming the image array is disclosed in WO 2014/070079 A1. Here it is taught that a matrix is provided whose surface comprises a plurality of recesses, the recesses are filled with a curable material, and a curable pickup layer is made to cover the recesses of the matrix. The curable pickup layer and the curable material are cured, fixing them together, and the pickup later is separated from the matrix, removing the material from the recesses. The pickup layer is, at some point during or after this process, transferred onto a substrate layer so that the pattern is provided on the substrate layer.

The above embodiments have been described with reference to exemplary colour changes that have been used to illustrate the secure visual effect of the invention. Examples of suitable ink formulae that may be used in the present invention may be found in WO2004/050376 and WO2018/206936. Particular examples are set out below, although some adjustments may be necessary as will be readily understood by the skilled person to achieve the desired colours and colour matching. It will be noted that in these cases the ink composition includes one or more visible (non-luminescent) pigments or dyes in addition to the luminescent material, which will typically be necessary unless the luminescent materials have the desired visible body colour. In these examples, each pigment or dye is supplied in the form of a base ink which also includes a binder (ink vehicle) of conventional composition, although this could be added separately. Also included in this case are additives such as driers, to improve the performance of the ink, which are optional.

| Red ink luminescing green | |
|---|---|
| 9C3002B Bluish Red Base ink (ex SICPA) | 16.8% |
| 9H0011B Transparent White Base ink (ex SICPA) | 32.8% |
| 9C5033B Yellowish Green Fluorescent Base ink (ex SICPA) | 49.7% |
| Cobalt Driers | 0.7% |
| Red ink luminescing orange | |
| 9C3002B Bluish Red Base ink (ex SICPA) | 16.8% |
| 9H0011B Transparent White Base ink (ex SICPA) | 32.8% |
| 9C1979B Yellow Fluorescent Base ink (ex SICPA) | 49.7% |
| Cobalt Driers | 0.7% |
| Green ink luminescing red | |
| 9C1033B Reddish Yellow Base ink (ex SICPA) | 7.0% |
| 9C5000B Green Base ink (ex SICPA) | 2.6% |
| 9H0011B Transparent White Base ink (ex SICPA) | 39.8% |
| 9C3901B Red Fluorescent Base ink (ex SICPA) | 50.0% |
| Cobalt Driers | 0.6% |
| Green ink luminescing yellow | |
| 9C1033B Reddish Yellow Base ink (ex SICPA) | 7.0% |
| 9C5000B Green Base ink (ex SICPA) | 2.7% |
| 9H0011B Transparent White Base ink (ex SICPA) | 69.7% |
| 9C1979B Yellowish Fluorescent Base ink (ex SICPA) | 20.0% |
| Cobalt Driers | 0.6% |

The first two inks described above are responsive to substantially all UV wavelengths in the range 235 to 380 nm and so both inks will display the desired colour change when illuminated with any one UV wavelength in that range (e.g. plus visible light). However, this is not essential and in other cases the luminescent ink need only be responsive to one or more UV wavelengths.

The embodiments described above been “one-dimensional” devices, in which the focussing elements are configured to focus light in one dimension. Thus, the lenses have been described as elongate cylindrical lenses, with the image segments being in the form of elongate line elements. However, it will be appreciated that the same concepts descried above may be extended to two-dimensional devices where the focussing elements are configured to focus light in two directions (for example spherical or aspherical lenses), as would be understood by the skilled person. For example, adaptations to the geometry of the image elements (e.g. an arrangement of the image elements in an interlaced grid form rather than elongate line elements) may be made in order to generate the desired effect upon tilting the device about two different tilt axes.

Security devices of the sorts described above can be incorporated into or applied to any product for which an authenticity check is desirable. In particular, such devices may be applied to or incorporated into documents of value such as banknotes, passports, driving licences, cheques, identification cards etc. The image array and/or the complete security device can either be formed directly on the security document (preferably using the methods described in WO-A-2018/153840 and WO-A-2017/009616), or may be supplied as part of a security article, such as a security thread or patch, which can then be applied to or incorporated into such a document.

Such security articles can be arranged either wholly on the surface of the base substrate of the security document, as in the case of a stripe or patch, or can be visible only partly on the surface of the document substrate, e.g. in the form of a windowed security thread. Security threads are now present in many of the world's currencies as well as vouchers, passports, travellers' cheques and other documents. In many cases the thread is provided in a partially embedded or windowed fashion where the thread appears to weave in and out of the paper and is visible in windows in one or both surfaces of the base substrate. One method for producing paper with so-called windowed threads can be found in EP-A-0059056. EP-A-0860298 and WO-A-03095188 describe different approaches for the embedding of wider partially exposed threads into a paper substrate. Wide threads, typically having a width of 2 to 6 mm, are particularly useful as the additional exposed thread surface area allows for better use of optically variable devices, such as that presently disclosed.

The security article may be incorporated into or on the surface of a paper or polymer base substrate so that it is viewable from both sides of the finished security substrate at at least one window of the document. Methods of incorporating security elements in such a manner are described in EP-A-1141480 and WO-A-03054297. In the method described in EP-A-1141480, one side of the security element is wholly exposed at one surface of the substrate in which it is partially embedded, and partially exposed in windows at the other surface of the substrate.

Base substrates suitable for making security substrates for security documents may be formed from any conventional materials, including paper and polymer. Techniques are known in the art for forming substantially transparent regions in each of these types of substrate. For example, WO-A-8300659 describes a polymer banknote formed from a transparent substrate comprising an opacifying coating on both sides of the substrate. The opacifying coating is omitted in localised regions on both sides of the substrate to form a transparent region. In this case the transparent substrate can be an integral part of the security device or a separate security device can be applied to the transparent substrate of the document. WO-A-0039391 describes a method of making a transparent region in a paper substrate. Other methods for forming transparent regions in paper substrates are described in EP-A-723501, EP-A-724519, WO-A-03054297 and EP-A-1398174.

The security device may also be applied to one side of a paper substrate, optionally so that portions are located in an aperture formed in the paper substrate. An example of a method of producing such an aperture can be found in WO-A-03054297. An alternative method of incorporating a security element which is visible in apertures in one side of a paper substrate and wholly exposed on the other side of the paper substrate can be found in WO-A-2000/39391.

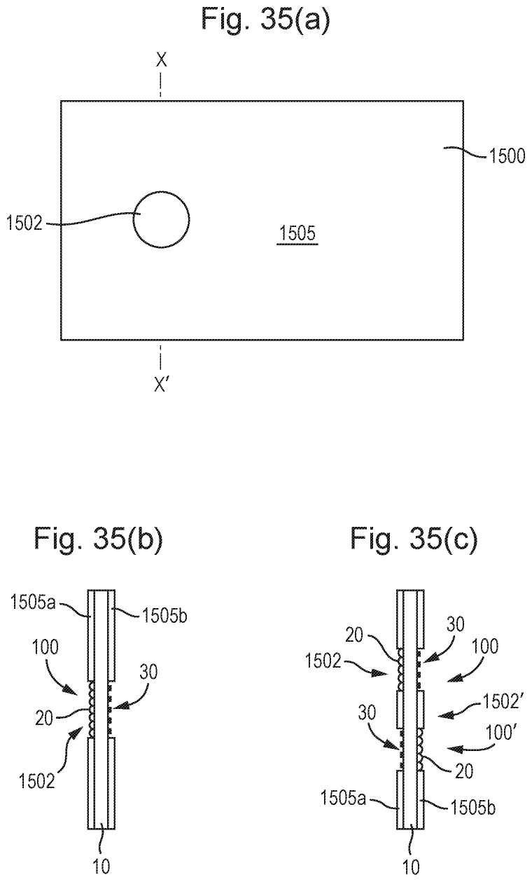

Examples of documents of value and techniques for incorporating a security device will now be described with reference to FIGS. 35 to 38.

FIG. 35 depicts an exemplary document of value 1500, here in the form of a banknote. FIG. 35(a) shows the banknote in plan view whilst FIG. 35(b) shows a cross-section of the same banknote along the line X-X′ and FIG. 35(c) shows a cross-section through a variation of the banknote. In this case, the banknote is a polymer (or hybrid polymer/paper) banknote, having a transparent substrate 10. Two opacifying layers 1505a and 1505b are applied to either side of the transparent substrate 10, which may take the form of opacifying coatings such as white ink, or could be paper layers laminated to the substrate 10.

The opacifying layers 1505a and 1505b are omitted across selected regions 1502 (and 1502′), each of which forms a window within which a security device 100, 100′ is located. In FIG. 35(b), a security device 100 is disposed within window 1502, with a focusing element array 20 arranged on one surface of the transparent substrate 10, and image layer 30 on the other. FIG. 35(c) shows a variation in which a second security device 100′ is also provided on banknote 1500, in a second window 1502′. The arrangement of the second security device 100′ can be reversed so that its optically variable effect is viewable from the opposite side of the security document as that of device 100, if desired.

It will be appreciated that, if desired, any or all of the windows 1502, 1502′ could instead be “half-windows”, in which an opacifying layer (e.g. 1505a or 1505b) is continued over all or part of the image array 30. Depending on the opacity of the opacifying layers, the half-window region will tend to appear translucent relative to surrounding areas in which opacifying layers 1505a and 1505b are provided on both sides.

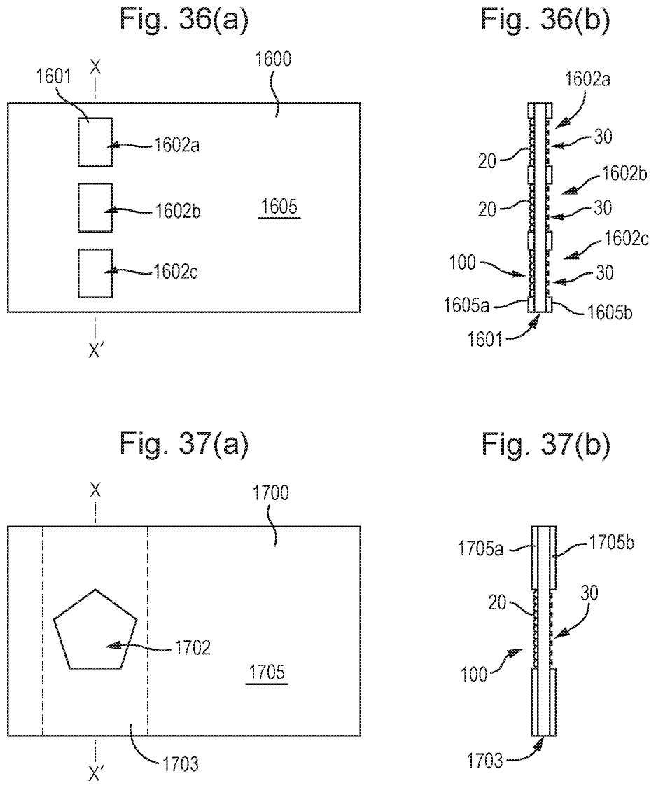

In FIG. 36 the banknote 1600 is a conventional paper-based banknote provided with a security article 1601 in the form of a security thread, which is inserted during paper-making such that it is partially embedded into the paper so that portions of the paper 1605a and 1605b lie on either side of the thread. This can be done using the techniques described in EP0059056 where paper is not formed in the window regions during the paper making process thus exposing the security thread 1601 in window regions 1602a,b,c of the banknote. Alternatively the window regions 1602a,b,c may for example be formed by abrading the surface of the paper in these regions after insertion of the thread. It should be noted that it is not necessary for the window regions to be “full thickness” windows: the thread 1601 need only be exposed on one surface if preferred. For example, in some embodiments the windows are “half-thickness” windows, and the paper is continuous on the side of the image array 30 with only the lens array 20 exposed. The security device is formed on the thread 1601, which comprises a transparent substrate, a focusing array 20 provided on one side and an image array 30 provided on the other. Windows 1602a, 1602b, 1602c reveal parts of the device 100, which may be formed continuously along the thread. (In the illustration, the lens arrays are depicted as being discontinuous between each exposed region of the thread, although in practice typically this will not be the case and the lens arrays (and image array) will be formed continuously along the thread. Alternatively several security devices could be spaced from each other along the thread, as in the embodiment depicted, with different or identical images displayed by each).

In FIG. 37, the banknote 1700 is again a conventional paper-based banknote, provided with a strip element or insert 1703. The strip 1703 is based on a transparent substrate and is inserted between two plies of paper 1705a and 1705b. The security device 100 is formed by an array of focusing features provided by a lens array 20 on one side of the strip substrate 1703, and an image array 30 on the other. The paper plies 1705a and 1705b are apertured across region 1702 to reveal the security device 100, which in this case may be present across the whole of the strip 1703 or could be localised within the aperture region 1702. It should be noted that the ply 1705b need not be apertured and could be continuous across the security device.

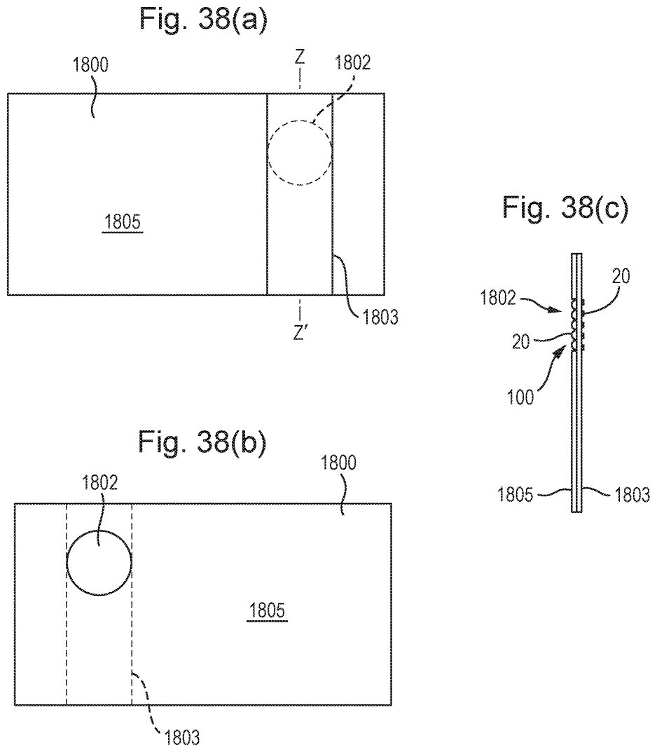

A further embodiment is shown in FIG. 38 where FIGS. 38(a) and 38(b) show the front and rear sides of the document 1800 respectively, and FIG. 38(c) is a cross section along line Z-Z′. Security article 1803 is a strip or band comprising a security device 100 according to any of the embodiments described above. The security article 1803 is formed into a security document 1800 comprising a fibrous substrate 1805, using a method described in EP-A-1141480. The strip is incorporated into the security document such that it is fully exposed on one side of the document (FIG. 38(a)) and exposed in one or more windows 1802 on the opposite side of the document (FIG. 38(b)). Again, the security device 100 is formed on the strip 1803, which comprises a transparent substrate with a lens array 20 formed on one surface and a co-operating image layer 30 as previously described on the other.

Alternatively a similar construction can be achieved by providing paper 1800 with an aperture 1802 and adhering the strip element 1803 onto one side of the paper 1800 across the aperture 1802. The aperture may be formed during papermaking or after papermaking for example by die-cutting or laser cutting.

In still further embodiments, a complete security device 100 could be formed entirely on one surface of a security document which could be transparent, translucent or opaque, e.g. a paper banknote irrespective of any window region. The image layer 30 can be affixed to the surface of the substrate, e.g. applying it directly thereto, or by forming it on another film which is then adhered to the substrate by adhesive or hot or cold stamping, either together with a corresponding focusing element array 20 or in a separate procedure with the focusing array 20 being applied subsequently.

In general when applying a security article such as a strip or patch carrying the security device to a document, it is preferable to bond the article to the document substrate in such a manner which avoids contact between those focusing elements, e.g. lenses, which are preferably utilised in generating the desired optical effects and the adhesive, since such contact can render the lenses inoperative. For example, the adhesive could be applied to the lens array(s) as a pattern that leaves an intended windowed zone of the lens array(s) uncoated, with the strip or patch then being applied in register (in the machine direction of the substrate) so the uncoated lens region registers with the substrate hole or window.

1. An optically variable security device, comprising:
a substrate;
an array of focussing elements disposed in or on the substrate; and
an image array disposed in or on the substrate and overlapping with the array of focussing elements, wherein the image array comprises at least first and second sets of image elements, the first set of image elements and the second set of image elements being interleaved with each other, and wherein the array of focussing elements and the image array cooperate with each other such that at a first range of viewing angles, light from the first set of image elements is directed to a viewer, and at a second range of viewing angles, light from the second set of image elements is directed to the viewer such that the device exhibits respective images at the first and second ranges of viewing angles; wherein
the image array comprises a first ink and a second ink different from the first ink, one or both of the first and second inks comprising a luminescent material which luminesces in response to irradiation at at least one excitation wavelength, wherein the first and second inks each exhibit a respective non-luminescent visible colour when illuminated with a first illumination condition that comprises illumination with visible light in the absence of the at least one excitation wavelength, and one or both of the first and second inks exhibit a visible colour when illuminated with a second illumination condition that comprises illumination with the at least one excitation wavelength; and further wherein
at least one of the first ink and the second ink exhibits a different visual appearance when illuminated with the first illumination condition compared to when illuminated with the second illumination condition, and when illuminated with at least one of the first and second illumination conditions, the first and second inks have different visual appearances from each other; such that
the security device exhibits a first optical effect when illuminated with the first illumination condition and tilted from the first range of viewing angles to the second range of viewing angles, and exhibits a second optical effect when illuminated with the second illumination condition and tilted from the first range of viewing angles to the second range of viewing angles, the second optical effect being different from the first optical effect, and wherein at least one of the first and second optical effects is an optically variable effect.

2. The security device of claim 1, wherein when the security device is illuminated with one of the first and second illumination conditions, the first and second inks exhibit substantially the same visible colours.

3. The security device of claim 1, wherein both the first and second inks comprise a luminescent material which luminesces in response to irradiation at the at least one excitation wavelength so as to exhibit a visible colour when illuminated with the second illumination condition.

4. The security device of claim 1, wherein, when illuminated with the first illumination condition, the first and second inks exhibit substantially the same non-luminescent visible colours.

5. The security device of claim 4, wherein both the first and second inks comprise a luminescent material which luminesces in response to irradiation at the at least one excitation wavelength so as to exhibit a visible colour when illuminated with the second illumination condition, and wherein when illuminated with the second illumination condition, the second ink exhibits a visible colour that is different from the visible colour exhibited by the first ink.

6. The security device of claim 3, wherein, when illuminated with the first illumination condition, the first and second inks exhibit different non-luminescent visible colours, and when illuminated with the second illumination condition, the first and second inks exhibit substantially matching visible colours.

7. The security device of claim 1, wherein at least one of the first ink and the second ink exhibits a different visible colour when illuminated with the first illumination condition compared to when illuminated with the second illumination condition.

8. The security device of claim 1, wherein the first set of image elements comprises the first ink, but not the second ink; and the second set of image elements comprises the second ink, but not the first ink.

9. The security device of claim 8, wherein, when illuminated with one of the first or second illumination conditions, the security device exhibits substantially the same image at both the first set of viewing angles and the second set of viewing angles, and when illuminated with the other of the first or second illumination conditions, the security device exhibits different images at the first set of viewing angles and the second set of viewing angles.

10. The security device of claim 1, wherein the first set of image elements comprises both the first ink and the second ink.

11. The security device of claim 10, wherein, when illuminated with the first illumination condition, the security device exhibits a first image at the first range of viewing angles; and when illuminated with the second illumination condition, the security device exhibits a second image at the first range of viewing angles, wherein the graphical form of the first image is different from the graphical form of the second image.

12-14. (canceled)

15. The security device according to of claim 1, further comprising a cover layer on or extending over the image array, wherein the cover layer exhibits a visible colour when illuminated with at least one of the first or second illumination conditions.

16. (canceled)

17. (canceled)

18. The security device of claim 1, wherein each of the first and second optical effects comprises the security device exhibiting at least one image as the device is tilted from the first range of viewing angles to the second range of viewing angles.

19-21. (canceled)

22. The security device of claim 1, wherein at least one image exhibited by the device is in the form of indicia or an indicium.

23. (canceled)

24. (canceled)

25. The security device of claim 1, wherein the at least one excitation wavelength is at least one UV wavelength in the range of 200 nm to 400 nm.

26. (canceled)

27. The security device of claim 1, wherein at least one of the first and second inks comprises a luminescent material that is phosphorescent.

28. The security device of claim 1, wherein the security device further comprises a static print working configured such that, when the device is illuminated with the second illumination condition, the static print working forms a combined image with at least one of the first and second sets of image elements at the respective range of viewing angles.

29. The security device of claim 1, wherein the array of focussing elements comprises an array of lenses.

30-34. (canceled)

35. A security document or a security article comprising a security device according to claim 1.

36. A method of manufacturing a security device, comprising:
(a) providing a substrate;
(b) applying an array of focussing elements to the substrate; and
(c) forming an image array in or on the substrate, the image array overlapping with the array of focussing elements; wherein the image array comprises at least first and second sets of image elements, the first set of image elements and the second set of image elements being interleaved with each other, and wherein the array of focussing elements and the image array cooperate with each other such that at a first range of viewing angles, light from the first set of image elements is directed to a viewer, and at a second range of viewing angles, light from the second set of image elements is directed to the viewer such that the device exhibits respective images at the first and second ranges of viewing angles; wherein
the image array comprises a first ink and a second ink different from the first ink, one or both of the first and second inks comprising a luminescent material which luminesces in response to irradiation at at least one excitation wavelength, wherein the first and second inks each exhibit a respective non-luminescent visible colour when illuminated with a first illumination condition that comprises illumination with visible light in the absence of the at least one excitation wavelength, and one or both of the first and second inks exhibit a visible colour when illuminated with a second illumination condition that comprises illumination with the at least one excitation wavelength; and further wherein
at least one of the first ink and the second ink exhibits a different visual appearance when illuminated with the first illumination condition compared to when illuminated with the second illumination condition, and under at least one of the first and second illumination conditions, the first and second inks have different visual appearances from each other; such that
the security device exhibits a first optical effect when illuminated with the first illumination condition and tilted from the first range of viewing angles to the second range of viewing angles, and exhibits a second optical effect when illuminated with the second illumination condition and tilted from the first range of viewing angles to the second range of viewing angles, the second optical effect being different from the first optical effect, and wherein at least one of the first and second optical effects is an optically variable effect.

37-43. (canceled)
